(19) United States
(12) Patent Application Publication
(10) Pub. No.: US 2008/0069710 A1
(43) Pub. Date: Mar. 20, 2008

(54) Electric motor and fuel pump having the same

(75) Inventors: Kenzou Kiyose, Takahama-city (JP); Kiyonori Moroto, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/802,571

(22) Filed: May 23, 2007

(30) Foreign Application Priority Data
May 24, 2006 (JP) 2006-144048
May 24, 2006 (JP) 2006-144103
May 24, 2006 (JP) 2006-144156
Jan. 9, 2007 (JP) 2007-1260
May 10, 2007 (JP) 2007-125418

(51) Int. Cl. F04D 3/00; H02K 13/10

(52) U.S. Cl. 417/423.1; 310/242; 415/55.1

(57) ABSTRACT

There are provided a positive-electrode brush and a negative-electrode brush, which contact with a commutator to conduct electricity, a positive-electrode spring, which biases the positive-electrode brush against the commutator, a negative-electrode spring, which biases the negative-electrode brush against the commutator, and a partition member defining a fuel passage hole, through which fuel passes to a brush accommodating passage from a motor accommodating passage. The positive-electrode spring is arranged offset from the positive-electrode brush and the negative-electrode spring is arranged offset from the negative-electrode brush. Further, the fuel passage hole defined in the partition member is arranged between both the springs when being viewed from the rotation axis.

### CROSS REFERENCE TO RELATED APPLICATIONS

This application is based on and incorporates herein by reference Japanese Patent Applications No. 2006-144048 filed on May 24, 2006, No. 2006-144103 filed on May 24, 2006, No. 2006-144156 filed on May 24, 2006, No. 2007-1260 filed on Jan. 9, 2007, and No. 2007-125418 filed on May 10, 2007.

### FIELD OF THE INVENTION

The present invention relates to an electric motor having a brush in contact with a commutator. The invention relates to a fuel pump including a pump part for pressurizing fuel and an electric motor.

### BACKGROUND OF THE INVENTION

Conventionally, a fuel pump, which includes a pump part for pressurizing fuel and a motor part for driving the pump part, is known. The pump part and the motor part are integrated in a case member.

As described in U.S. Pat. No. 6,326,716 B1 (JP-A-2000-312458), JP-U-5-95183 and U.S. Pat. No. 6,952,066B2, a motor includes an armature, a commutator for rectifying a current supplied to the armature, a brush in contact with the commutator to supply electricity, a biasing member for biasing the brush against the commutator, and the like. The biasing member includes a coil-shaped body portion, which is resiliently deformable, and an arm portion, which transmits biasing force from the body portion to the brush. The body portion is arranged offset from the brush when being viewed from the rotation axis of the commutator to reduce the motor small in size relative to the axial direction.

In order to make a fuel pump small in size relative to the axial direction, it is conceivable to adopt that construction, in which a body portion of a biasing member is arranged offset as described above, for a motor part of the fuel pump. When such offset arrangement is adopted, however, the fuel pump becomes radially large in size in order to ensure a space for accommodating the body portion.

FIG. 16A is a cross sectional view showing shapes of a biasing member 93 and a holder 831 in JP-U-5-95183. As shown in FIG. 16A, the holder 831 is formed to be in a cylindrical shape extending along the rotation axis (vertical direction in the figure) of a commutator 60 to hold a brush 81 movably in the cylinder. In addition, the biasing member 93 includes a body portion 932 arranged outside the cylinder of the holder 831 and an arm portion 933 arranged in a draw hole 833 formed in the holder 831 to extend from the body portion 932 toward the interior of the cylinder of the holder 831.

In the conventional construction shown in FIG. 16A, however, the draw hole 833 is defined in a wall portion 832 located on the opposite side to the forward side in the rotative direction of the commutator 60. In the construction, as the commutator 60 rotates, the brush 81 receives frictional force from the commutator 60, and the frictional force inclines the brush 81 in the holder 831. Consequently, a wall portion opposed surface 801 of an upper portion of the brush 81 in opposition to the wall portion 832 is biased against the wall portion 832. However, the wall portion 832 defines the draw hole 833, and consequently, the wall portion opposed surface 801 of the brush 81 is decreased in pressure receiving area (see FIG. 16B, which is a view taken along an arrow XVIB in FIG. 16A).

In this case, the portion (hatched portion 802 in FIG. 16B) of the wall portion opposed surface 801, which is biased against the wall portion 832, is damaged due to abrasion.

JP-U-5-95183 describes a biasing member for biasing a brush in a direction to bias the brush against a commutator. The biasing member includes a body portion, which is resiliently deformable and arranged offset from the brush when being viewed from the rotation axis of the commutator, and an arm portion, which abuts against the brush to transmit biasing force of the body portion to the brush.

As shown in FIG. 23, the arm portion 933 is conventionally generally caused to abut against the brush 81 in a position of an axis L1 to bias the brush 81 vertically toward the commutator 60.

The commutator 60 is formed from segments, and the respective segments make contact with the brush 81, whereby an electric current supplied to an armature is interrupted. When contact between the brush 81 and the rotating commutator 60 is released, electric discharge accompanying a residual current is liable to generate between the brush 81 and the commutator 60. When electric discharge generates between the brush 81 and the commutator 60, the brush 81 and the commutator 60 electrically abrade, and lifetime is shortened.

According to a state, in which the brush 81 is biased against the commutator 60, electric discharge generating between the brush 81 and the commutator 60 changes. Specifically, electric discharge between the brush 81 and the commutator 60 is decreased when biased against an approach side contact portion 81a being a portion of the brush 81, at which in contact with the commutator 60 begins. The electric discharge between the brush 81 and the commutator 60 is increased when biased against a release side contact portion 81b being a portion of the brush 81, at which in contact with the commutator 60 is released.

In a conventional, general construction shown in FIG. 23, the arm portion 933 is caused to abut against the axis L1 of the brush 81 to be responsible for an increase in electric discharge. That is, as the brush 81 abrades, an abutment position (force point position) P1, in which the arm portion 933 abuts against the brush 81, shifts on a locus indicated by a two-dot chain line K2 in FIG. 23 and shifts from an axial position of the brush 81 to the forward side in a rotating direction of the commutator 60. Consequently, the release side contact portion 81b of the brush 81 is biased against the commutator 60 to lead to an increase in electric discharge between the brush 81 and the commutator 60, so that shortening the brush 81 and the commutator 60 in life is brought about.

### SUMMARY OF THE INVENTION

The present invention addresses the above disadvantage.

According to one aspect of the present invention, a fuel pump includes a case member having therein a fuel passage, an inlet of fuel, and an outlet of fuel. The fuel pump further includes a pump part provided in the fuel passage to draw fuel from the inlet to pressure feed the fuel to the outlet. The fuel pump further includes an armature provided to a motor accommodating passage downstream of the pump part in the fuel passage for rotating to drive the pump part. The fuel pump further includes a commutator provided to the motor accommodating passage to rectify an electric current fed to the armature. The fuel pump further includes a positive-electrode brush and a negative-electrode brush, which are provided to a brush accommodating passage downstream of the motor accommodating passage in the fuel passage, and are in contact with the commutator to conduct electricity. The fuel pump further includes a positive-electrode biasing member and a negative-electrode biasing member provided to the brush accommodating passage respectively to bias the positive-electrode brush against the commutator and the negative-electrode brush against the commutator. The fuel pump further includes a partition member partitioning the fuel passage into the motor accommodating passage and the brush accommodating passage, and defining a fuel passage hole through which fuel passes from the motor accommodating passage to the brush accommodating passage. The positive-electrode biasing member includes a positive-electrode body, which is resiliently deformable and arranged offset from the positive-electrode brush when being viewed from a rotation axis of the commutator, and a positive-electrode arm for transmitting biasing force from the positive-electrode body to the positive-electrode brush. The negative-electrode biasing member includes a negative-electrode body, which is resiliently deformable and arranged offset from the negative-electrode brush when being viewed from the rotation axis of the commutator, and a negative-electrode arm for transmitting biasing force from the negative-electrode body to the negative-electrode brush. The fuel passage hole is located between the positive-electrode body and the negative-electrode body when being viewed from the rotation axis of the commutator.

According to another aspect of the present invention, a fuel pump includes a case member having therein a fuel passage, an inlet of fuel, and an outlet of fuel. The fuel pump further includes a pump part provided in the fuel passage to draw fuel from the inlet to pressure feed the fuel to the outlet. The fuel pump further includes an armature provided to a motor accommodating passage downstream of the pump part in the fuel passage for rotating to drive the pump part. The fuel pump further includes a commutator provided to the motor accommodating passage to rectify an electric current fed to the armature. The fuel pump further includes a positive-electrode brush and a negative-electrode brush, which are provided to a brush accommodating passage downstream of the motor accommodating passage in the fuel passage, and are in contact with the commutator to conduct electricity. The fuel pump further includes a positive-electrode biasing member and a negative-electrode biasing member provided to the brush accommodating passage respectively to bias the positive-electrode brush against the commutator and the negative-electrode brush against the commutator. The fuel pump further includes a partition member partitioning the fuel passage into the motor accommodating passage and the brush accommodating passage, and defining a fuel passage hole through which fuel passes from the motor accommodating passage to the brush accommodating passage. The fuel pump further includes a positive-electrode terminal and a negative-electrode terminal conducting electric power. The fuel pump further includes a positive-electrode choke coil electrically connecting the positive-electrode terminal with the positive-electrode brush to decrease electric noise. The fuel pump further includes a negative-electrode choke coil electrically connecting the negative-electrode terminal with the negative-electrode brush to decrease electric noise. The positive-electrode biasing member includes a positive-electrode body, which is resiliently deformable and arranged offset from the positive-electrode brush when being viewed from a rotation axis of the commutator, and a positive-electrode arm for transmitting biasing force from the positive-electrode body to the positive-electrode brush. The negative-electrode biasing member includes a negative-electrode body, which is resiliently deformable and arranged offset from the negative-electrode brush when being viewed from the rotation axis of the commutator, and a negative-electrode arm for transmitting biasing force from the negative-electrode body to the negative-electrode brush. The positive-electrode choke coil is arranged on an opposite side of the positive-electrode biasing member with respect to the positive-electrode brush when being viewed from the rotation axis of the commutator. The negative-electrode choke coil is arranged on an opposite side of the negative-electrode biasing member with respect to the negative-electrode brush when being viewed from the rotation axis of the commutator. The positive-electrode terminal is arranged on an opposite side of the positive-electrode brush with respect to the positive-electrode choke coil when being viewed from the rotation axis of the commutator. The negative-electrode terminal is arranged on an opposite side of the negative-electrode brush with respect to the negative-electrode choke coil when being viewed from the rotation axis of the commutator.

According to another aspect of the present invention, an electric motor includes an armature. The electric motor further includes a commutator for rectifying an electric current supplied to the armature. The electric motor further includes a brush being in contact with the commutator relative to a direction of a rotation axis of the commutator. The electric motor further includes a holder being in a cylindrical-shape extending along the rotation axis for supporting the brush therein movably along the rotation axis. The electric motor further includes a biasing member for biasing the brush against the commutator. The biasing member includes a body portion, which is resiliently deformable and arranged outside the holder when being viewed from the rotation axis. The biasing member includes an arm portion located in a draw hole defined in the holder to extend from the body portion into the holder. The holder has a wall portion defining the draw hole in an outer periphery or an inner periphery thereof with respect to a radial direction of the commutator.

According to another aspect of the present invention, an electric motor includes an armature. The electric motor further includes a commutator for rectifying an electric current supplied to the armature. The electric motor further includes a positive-electrode brush and a negative-electrode brush being in contact with the commutator with respect to a direction of a rotation axis of the commutator. The electric motor further includes a positive-electrode holder being in a cylindrical-shape extending along the rotation axis for supporting the positive-electrode brush therein movably along the rotation axis. The electric motor further includes a negative-electrode holder being in a cylindrical-shape extending along the rotation axis for supporting the negative-electrode brush therein movably along the rotation axis. The electric motor further includes a positive-electrode biasing member for biasing the positive-electrode brush against the commutator. The electric motor further includes a negative-electrode biasing member for biasing the negative-electrode brush against the commutator. The positive-electrode biasing member includes a positive-electrode body, which is resiliently deformable and arranged outside the positive-electrode holder when being viewed from the rotation axis. The positive-electrode biasing member includes a positive-electrode arm arranged in a positive-electrode draw hole defined in the positive-electrode holder to extend from the positive-electrode body into the positive-electrode holder. The negative-electrode biasing member includes a negative-electrode body, which is resiliently deformable and arranged outside the negative-electrode holder when being viewed from the rotation axis. The negative-electrode biasing member includes a negative-electrode arm arranged in a negative-electrode draw hole defined in the negative-electrode holder to extend from the negative-electrode body into the negative-electrode holder. The positive-electrode holder has a wall portion, which is located on a forward rotation side of the positive-electrode holder in a rotative direction of the commutator, and defining the positive-electrode draw hole. The negative-electrode holder has a wall portion, which is located on a forward rotation side of the negative-electrode holder in the rotative direction of the commutator, and defining the negative-electrode draw hole.

According to another aspect of the present invention, an electric motor includes an armature. The electric motor further includes a commutator for rectifying an electric current supplied to the armature. The electric motor further includes a brush being in contact with the commutator. The electric motor further includes a biasing member for biasing the brush toward the commutator. The biasing member includes a body portion, which is resiliently deformable and arranged offset from the brush when being viewed from a rotation axis of the commutator. The biasing member includes an arm portion, which abuts against the brush to transmit biasing force of the body portion to the brush. The arm portion is biased against the brush at a force point position, which is located on an opposite side of a forward side of the commutator 60 in a rotative direction, with respect to an axis of the brush.

### BRIEF DESCRIPTION OF THE DRAWINGS

The above and other objects, features and advantages of the present invention will become more apparent from the following detailed description made with reference to the accompanying drawings. In the drawings:

FIG. 1 is a cross sectional view showing a fuel pump according to a first embodiment;

FIG. 2 is a plan view showing a state, in which a discharge side cover is removed from the fuel pump,

FIG. 3 is a view as viewed along an arrow III in FIG. 1;

FIG. 4 is an enlarged view of FIG. 1 showing an arrangement of a negative-electrode brush;

FIG. 5 is an enlarged view of FIG. 4 showing an arrangement of the negative-electrode brush;

FIG. 6 is a plan view showing a fuel pump according to a second embodiment;

FIG. 7 is a plan view showing a fuel pump according to a third embodiment;

FIG. 8 is a plan view showing a fuel pump according to a fourth embodiment;

FIG. 9 is a plan view showing a fuel pump according to a fifth embodiment;

FIG. 10A is an enlarged view of FIG. 9 and FIG. 10B is a view as viewed along an arrow XB in FIG. 10A;

FIG. 11 is a plan view showing a fuel pump according to a sixth embodiment;

FIG. 12 is a plan view showing a fuel pump according to a seventh embodiment;

FIG. 13 is a cross sectional view showing a fuel pump according to an eighth embodiment;

FIG. 14 is a plan view showing a fuel pump according to a ninth embodiment;

FIG. 15 is a plan view showing a fuel pump according to a tenth embodiment;

FIG. 16A is a side view showing conventional brush, biasing member, and holder and FIG. 16B is a view as viewed along an arrow XVIB in FIG. 16A;

FIG. 17 is a plan view showing a fuel pump according to an eleventh embodiment;

FIG. 18A is a view as viewed along an arrow XVIIIA in FIG. 17 and

FIG. 18B is a view as viewed along an arrow XVIIIB in FIG. 17;

FIG. 19A is a side view showing an arrangement of a positive-electrode brush according to a twelfth embodiment and FIG. 19B is a side view showing a negative-electrode brush according to the twelfth embodiment;

FIG. 20 is a plan view showing a fuel pump according to a thirteenth embodiment;

FIG. 21 is a plan view showing a fuel pump according to a fourteenth embodiment;

FIG. 22 is a plan view showing a fuel pump according to a fifteenth embodiment; and

FIG. 23 is a side view showing an arrangement of a brush according to a prior art.

### DETAILED DESCRIPTION OF PREFERRED EMBODIMENTS

### First Embodiment

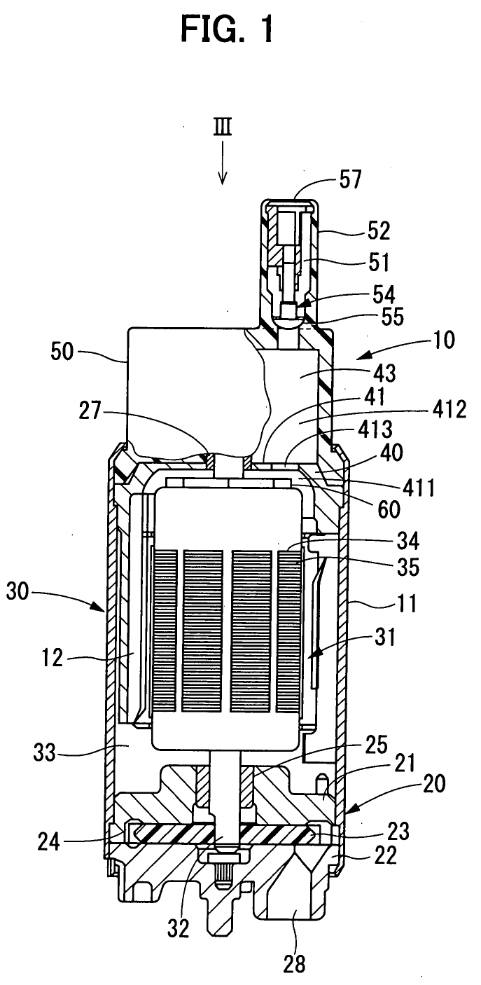

A fuel pump 10 shown in FIG. 1 is an in-tank type pump mounted in a fuel tank of, for example, a vehicle. The fuel pump 10 supplies fuel in the fuel tank to an engine. The fuel pump 10 includes a pump part 20, in which fuel as drawn is raised in pressure, and a motor part 30, which drives the pump part 20. The motor part 30 includes a direct current motor with a brush. The fuel pump 10 includes a substantially cylindrical-shaped housing 11. A permanent magnet 12 is mounted annularly on an inner wall surface of the housing 11 in a circumferential direction. An armature 31 is arranged on an inner peripheral side of the permanent magnet 12 to be coaxial with the annular permanent magnet 12.

The pump part 20 includes an impeller 23 arranged between a casing body 21 and a casing cover 22, and the like. The casing body 21 and the casing cover 22 define a substantially C-shaped pump flow passage 24. The impeller 23 is accommodated rotatably between the casing body 21 and the casing cover 22. The casing body 21 and the casing cover 22 are formed by, for example, aluminum die-casting.

The casing body 21 is fixed to one end side of the housing 11 in the axial direction by press fitting. A bearing 25 is mounted centrally of the casing body 21. The casing cover 22 is fixed to one end of the housing 11 by crimping or the like in a state of covering the casing body 21. One end of a shaft 32 of the armature 31 is supported rotatably by the bearing 25 in the radial direction. The other end of the shaft 32 is supported rotatably by a bearing 27 in the radial direction.

The casing cover 22 includes an inlet 28, through which fuel is drawn. When the impeller 23 having a vane groove at a peripheral edge thereof rotates in the pump flow passage 24, fuel in a fuel tank (not shown) is drawn into the pump flow passage 24 from the inlet 28. The fuel drawn into the pump flow passage 24 is raised in pressure by rotation of the impeller 23 to be discharged to a pump chamber 33 of the motor part 30.

A motor casing 40 and a discharge-side cover 50 are mounted at the other end of the housing 11, that is, on the opposite side to the casing body 21 and the casing cover 22. The motor casing 40 is interposed between the discharge-side cover 50 and the housing 11. The discharge-side cover 50 is fixed to the housing 11 by crimping. In addition, “case member” in the embodiment is constructed of the housing 11, the casing cover 22, and the discharge-side cover 50.

As shown in FIG. 3, the discharge-side cover 50 includes a fuel discharge portion 52 and a connector 53.

The fuel discharge portion 52 includes a fuel passage 51 and a pressure regulating valve 54 as shown in FIG. 1. The fuel passage 51 is opened and closed by a valve member 55 of the pressure regulating valve 54. When fuel pressure in the fuel pump 10 exceeds a predetermined value, the valve member 55 opens the fuel passage 51. The fuel, pressure of which is raised by the pump part 20, is supplied outside the fuel pump 10 through a piping (not shown) connected from an outlet 57 of the fuel discharge portion 52 to the outlet 57.

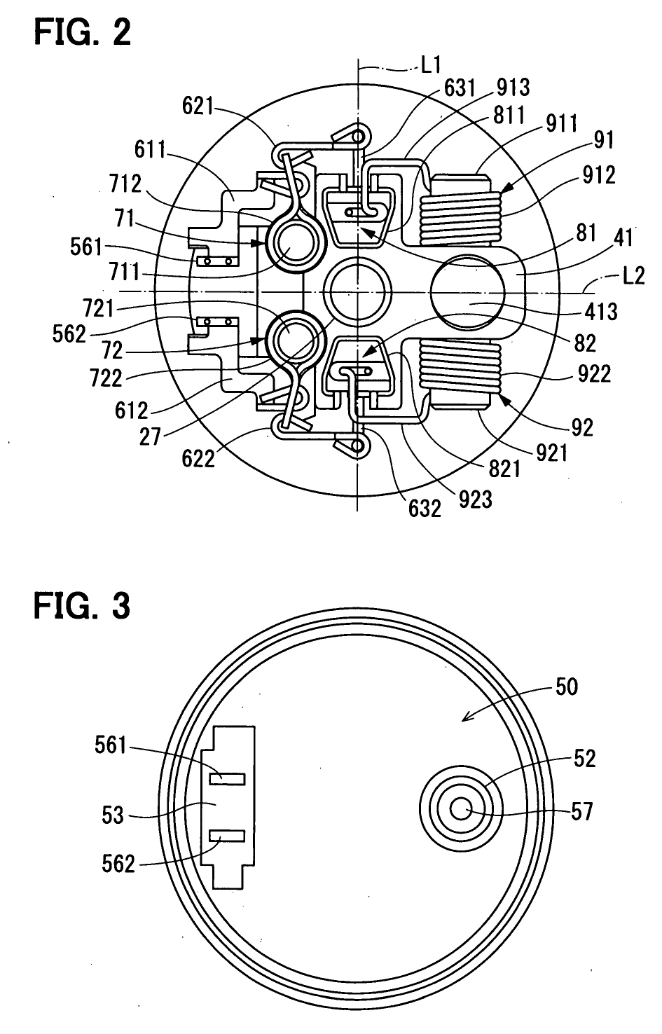

As shown in FIGS. 2 and 3, the connector 53 includes a positive-electrode terminal 561 and a negative-electrode terminal 562.

As shown in FIG. 1, the armature 31 is accommodated rotatably in an internal space of the housing 11. The armature 31 includes a core 34 and a coil 35 wound around an outer periphery of the core 34. The commutator 60 is formed to be disk-shaped and mounted above the armature 31 in FIG. 1. That is, the commutator 60 is mounted on the opposite side of the armature 31 to the pump part 20. The commutator 60 is in contact with the brushes 81, 82, which are biased by springs 91, 92 as biasing members. In addition, the brush 81 indicates a positive-electrode brush, the brush 82 indicates a negative-electrode brush, the spring 91 indicates a positive-electrode biasing member, and the spring 92 indicates a negative-electrode biasing member. In addition, depiction of the springs 91, 92 is omitted in FIG. 1.

As shown in FIG. 2, a positive-electrode choke coil 71 is electrically connected to the positive-electrode terminal 561 and the positive-electrode brush 81 to decrease electric noise generated when power supply begins. Likewise, a negative-electrode choke coil 72 is electrically connected to the negative-electrode terminal 562 and the negative-electrode brush 82 to decrease electric noise generated when power supply begins. In addition, both the choke coils 71, respectively, include cores 711, 721, and coils 712, 722 wound around the cores 711, 721.

The positive-electrode choke coil 71 and the positive-electrode terminal 561 are connected to each other by a conductive member 611. In addition, the positive-electrode choke coil 71 and the positive-electrode brush 81 are connected to each other by a conductive member 621 and a positive-electrode pigtail 631. Likewise, the negative-electrode choke coil 72 and the negative-electrode terminal 562 are connected to each other by a conductive member 612. In addition, the negative-electrode choke coil 72 and the negative-electrode brush 82 are connected to each other by a conductive member 622 and a pigtail 632.

In addition, the pigtails 631, 632 are conductive members, which are flexible and deformable following axial movements of the brushes 81, 82.

Electric power supplied to the terminals 561, 562 from an electric source (not shown) is fed to the coil 35 of the armature 31 through the conductive members 611, 612, the choke coils 71, 72, the conductive members 621, 622, the pigtails 631, 632, the brushes 81, 82, and the commutator 60 in this order. When electric power as supplied causes the armature 31 to rotate, the impeller 23 rotates together with the shaft 32 of the armature 31. In addition, when the armature 31 rotates, the commutator 60 also rotates in keeping therewith. At this time, the commutator 60 rotates while keeping contact with the brushes 81, 82.

When the impeller 23 rotates together with the shaft 32 of the armature 31, fuel is drawn into the pump flow passage 24 from the inlet 28. The fuel drawn into the pump flow passage 24 receives kinetic energy from the respective vane grooves of the impeller 23 to be discharged from the pump flow passage 24 into the pump chamber 33. The fuel discharged into the pump chamber 33 is supplied outside the fuel pump 10 from the outlet 57 via a periphery of the armature 31 and the fuel passage 51.

Subsequently, a detailed explanation will be given to an arrangement and a construction of the brushes 81, 82, the springs 91, 92, the choke coils 71, 72, and the terminals 561, 562 in an internal space of the discharge-side cover 50.

As shown in FIGS. 4, 5, and 2, the brushes 81, 82, the springs 91, 92, the choke coils 71, 72, the terminals 561, 562, and the like are held on a side of a partition member 41, which defines a part of the motor casing 40, toward the outlet 57.

The partition member 41 partitions the fuel passage in the casing members 11, 22, 50 into a motor accommodating passage 411 and a brush accommodating passage 412 shown in FIG. 1.

In addition, the partition member 41 is provided with a fuel passage hole 413, which provides communication between the motor accommodating passage 411 and the brush accommodating passage 412. Therefore, fuel in the motor accommodating passage 411 is discharged into the brush accommodating passage 412 from the fuel passage hole 413.

In addition, the brush accommodating passage 412 according to the embodiment corresponds to a space surrounded by the discharge-side cover 50 and the partition member 41. The brush accommodating passage 412 accommodates therein the brushes 81, 82, the springs 91, 92, the choke coils 71, 72, the terminals 561, 562, the conductive members 611, 612, 621, 622, the pigtails 631, 632, and the like. In addition, the motor accommodating passage 411 according to the embodiment corresponds to a space surrounded by the motor casing 40, the housing 11, and the casing body 21. The motor accommodating passage 411 accommodates therein the commutator 60, the armature 31, the permanent magnet 12, and the like.

Both the brushes 81, 82, respectively, are accommodated in brush holders 811, 821. The brush holders 811, 821 are cylindrical-shaped to extend axially and formed integrally with the partition member 41 of resin.

The positive-electrode brush 81 is held in a positive-electrode holder 811 to be made movable along the rotation axis, and the negative-electrode brush 82 is held in a negative electrode holder 821 to be made movable along the rotation axis.

The positive-electrode spring 91 includes a positive-electrode body 912, which is formed in a coiled manner and resiliently deformable, and a positive-electrode arm 913, which is in contact with an upper end of the positive-electrode brush 81 to transmit elastic force of the positive-electrode body 912 to the positive-electrode brush 81. The positive-electrode body 912 is arranged offset from the positive-electrode brush 81 when being viewed from the rotation axis of the commutator 60 (as viewed along an arrow 11 in FIG. 1). That is, the positive-electrode body 912 is arranged rightward offset from the positive-electrode brush 81 in FIG. 2. In addition, the positive-electrode body 912 is held by a shaft member 911 located in the coil.

The negative-electrode spring 92 is the same in structure as the positive-electrode spring 91 and includes a negative-electrode body 922 and a negative-electrode arm 923, the negative-electrode body 922 being arranged offset from the negative-electrode brush 82. The negative-electrode body 922 is held by a shaft member 921 located in the coil. In addition, both the shaft members 911, 921 are formed integrally with the partition member 41 of resin. In addition, both the electrode bodies 912, 922 are arranged with coil centers directed vertically in FIG. 2.

The fuel passage hole 413 defined in the partition member 41 is located between the positive-electrode body 912 and the negative-electrode body 922 when being viewed from the rotation axis of the commutator 60. In addition, the fuel passage hole 413 is arranged to overlap the outlet 57 of the fuel discharge portion 52 when being viewed from the rotation axis (see FIG. 1). In addition, the outlet 57 is arranged offset from the rotation axis when being viewed from the rotation axis (see FIGS. 3 and 1).

The positive-electrode choke coil 71 and the negative-electrode choke coil 72 are arranged on the opposite side of an imaginary line L1 (see FIG. 2), which connects an axis of the positive-electrode brush 81 with an axis of the negative-electrode brush 82, to the fuel passage hole 413 when being viewed from the rotation axis of the commutator 60.

In addition, the positive-electrode terminal 561 is arranged on the opposite side of the fuel passage hole 413 with respect to the positive-electrode choke coil 71 when being viewed from the rotation axis of the commutator 60. The negative-electrode terminal 562 is arranged on the opposite side of the fuel passage hole 413 with respect to the negative-electrode choke coil 72 when being viewed from the rotation axis.

In addition, both the choke coils 71, 72 are arranged with centers of the cores 711, 721 directed vertically in FIG. 2.

As shown in FIG. 2, on the opposite side of the imaginary line L1 to the fuel passage hole 413, the positive-electrode terminal 561, the positive-electrode choke coil 71, and the positive-electrode brush 81 are arranged to align in order from the left in FIG. 2. Likewise, the negative-electrode terminal 562, the negative-electrode choke coil 72, and the negative-electrode brush 82 are arranged to align in order from the left in FIG. 2.

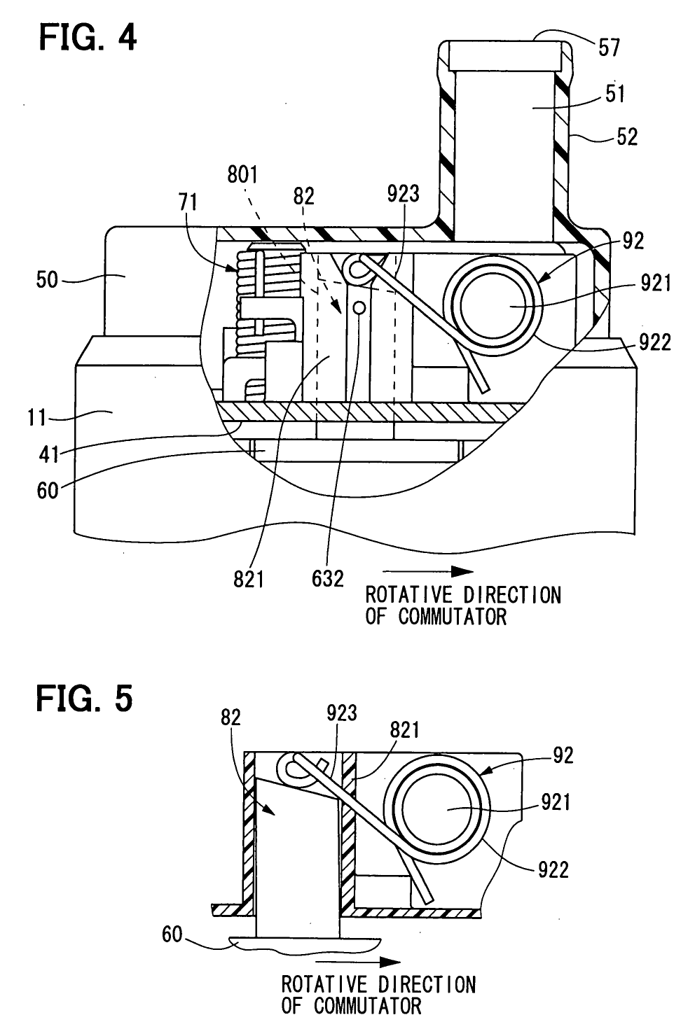

In addition, as shown in FIG. 4, the electrode bodies 912, 922 of both the springs 91, 92, both the terminals 561, 562, both the choke coils 71, 72, and both the brushes 81, 82 are arranged to overlap radially with respect to the rotation axis.

In addition, both the springs 91, 92, both the terminals 561, 562, both the choke coils 71, 72, and both the brushes 81, 82, respectively, are arranged to be symmetrical with respect to an imaginary line L2 (see FIG. 2), which connects the center of the rotation axis with a center of the fuel passage hole 413, when being viewed from the rotation axis of the commutator 60. In addition, both the brushes 81, 82 are arranged to be symmetrical with respect to the rotation axis.

As described above, according to the embodiment, the electrode bodies 912, 922 of both the springs 91, 92 are arranged offset from the brushes 81, 82 and arranged in positions, which axially overlap each other. Thereby, the fuel pump 10 can be axially downsized (vertical direction in FIG. 1).

In addition, the fuel passage hole 413 of the partition member 41 is located between the electrode bodies 912, 922 of both the springs 91, 92. Thereby, a space for arrangement of the electrode bodies 912, 922 can be efficiently ensured and the fuel pump 10 can be radially downsized. In addition, the fuel passage hole 413 is located between the electrode bodies 912, 922. Thereby, it is possible to ensure a large area for the fuel passage hole 413. Therefore, a fuel passing through the fuel passage hole 413 can be reduced in pressure loss, so that it is possible to improve the fuel pump 10 in discharge efficiency.

In addition, the outlet 57 of the fuel discharge portion 52 is arranged offset from the rotation axis. Therefore, a piping (not shown) connected to the outlet 57 can bear a force, with which the fuel pump 10 is going to rotate about the rotation axis as the armature 31 and the impeller 23 rotate. Therefore, a piping connected to the outlet 57 can be made use of as a support member for rotation of the fuel pump 10.

In addition, the fuel passage hole 413 of the partition member 41 is arranged to overlap the outlet 57 of the fuel discharge portion 52 when being viewed from the rotation axis. Therefore, in a fuel flow path leading to the outlet 57 from the fuel passage hole 413, a fuel can be decreased in pressure loss. Thereby, it is possible to improve the fuel pump 10 in discharge efficiency.

In addition, both the choke coils 71, 72 and both the terminals 561, 562 are arranged on the opposite side to the fuel passage hole 413 when being viewed from the rotation axis. Therefore, it is possible to inhibit a fuel discharged from the fuel passage hole 413 from striking directly against the choke coils 71, 72 and the terminals 561, 562. Thereby, in the fuel flow path leading from the fuel passage hole 413 to the outlet 57, it is possible to decrease fuel in pressure loss, thereby enabling improving the fuel pump 10 in discharge efficiency.

In addition, it is possible to restrict abrasion powder of the brushes 81, 82 contained in fuel from striking powerfully against both the choke coils 71, 72 and the terminals 561, 562. Thereby, it is possible to suppress damage to both the choke coils 71, 72 and the terminals 561, 562.

In addition, since the positive-electrode terminal 561, the positive-electrode choke coil 71, and the positive-electrode brush 81 are arranged to align in this order when being viewed from the rotation axis, a length of the conductive members 611, 621, which construct electric wiring for electric series connection, can be restricted from becoming large radially in the fuel pump 10. Likewise, the conductive members 611, 622, which construct electric wiring on a negative electrode side, can also be inhibited from becoming large radially in the fuel pump 10. Accordingly, the fuel pump 10 can be radially downsized.

### Second Embodiment

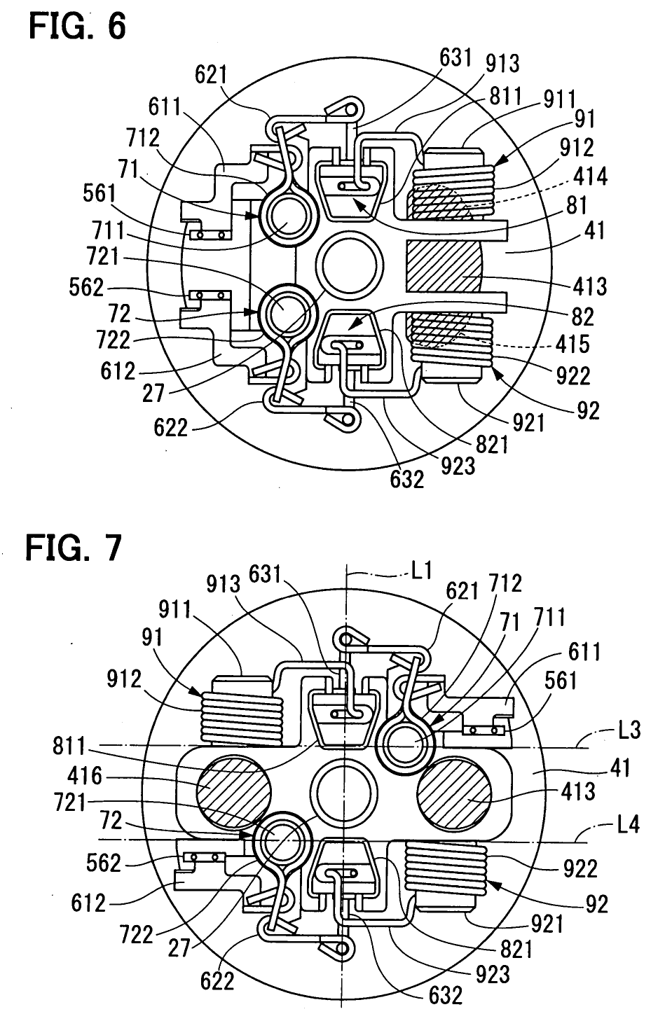

As shown in FIG. 6, according to the second embodiment, a plurality of fuel passage holes 413, 414, 415 are defined in the partition member 41. Hatched portions in FIG. 6 indicate three fuel passage holes 413, 414, 415. The fuel passage hole 413 is located between both the electrode bodies 912, 922 of the springs 91, 92. The fuel passage hole 414 is located below the positive-electrode body 912. The fuel passage hole 415 is located below the negative-electrode body 922.

Therefore, it is possible to ensure a further large, total area for the fuel passage hole 413. Thereby, it is possible to decrease fuel, which passes through the fuel passage hole 413, in pressure loss, thereby enabling improving the fuel pump 10 in discharge efficiency.

### Third Embodiment

As shown in FIG. 7, according to the third embodiment, two fuel passage holes 413, 416 are arranged to be symmetrical with respect to an imaginary line L1. In addition, a positive-electrode spring 91 and a negative-electrode choke coil 72 are arranged in positions, which are symmetrical about the imaginary line L1 relative to the positive-electrode spring 91 and the negative-electrode choke coil 72 in the first embodiment.

The fuel passage holes 413, 416 are located between both the electrode bodies 912, 922 of the springs 91, 92. More specifically, the fuel passage holes 413, 416 are located between an imaginary line L3, which extends from an end of the positive-electrode body 912 in a direction perpendicular to the axial direction of the shaft member 911, and an imaginary line L4, which extends from an end of the negative-electrode body 922 in a direction perpendicular to the axial direction of the shaft member 921.

### Fourth Embodiment

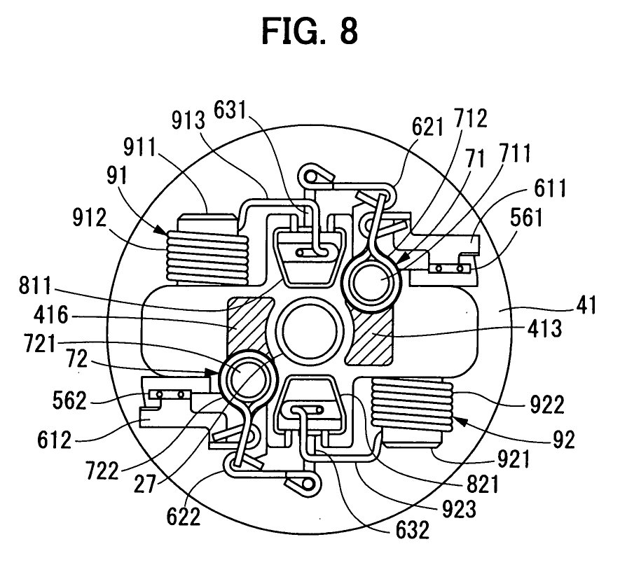

As shown in FIG. 8, in a fuel pump according to the fourth embodiment, the fuel passage holes 413, 416 in the third embodiment are shifted to positions near to the rotation axis. In addition, while the fuel passage holes 413, 416 in the third embodiment are substantially circular in shape, the fuel passage holes 413, 416 in the present embodiment are shaped to correspond to the outer peripheral shapes of the coils 712, 722 of the choke coils 71, 72 and the outer peripheral shape of the bearing 27.

### Fifth Embodiment

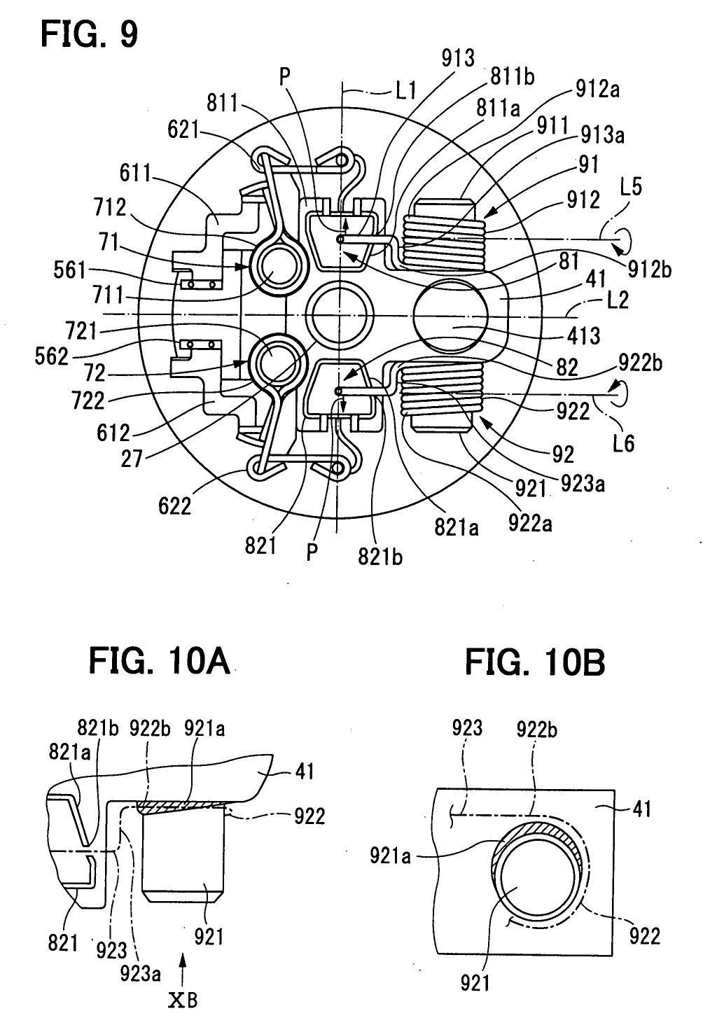

The positive-electrode body 912 and the negative-electrode body 922 shown in FIGS. 9, 10A, and 10B include torsion springs wound around respective shaft members 911, 921. Here, those ends of the positive-electrode body 912 and the negative-electrode body 922, which are located radially outside relative to the rotation axis of the commutator 60, are called as engagement ends 912a, 922a and the other ends are called as arm draw portions 912b, 922b. In addition, the shaft members 911, 921 extend in parallel to an imaginary line L1 to correspond to “positive-electrode column” and “negative-electrode column”. In addition, the shaft members 911, 921 are formed integrally with the partition member 41 of resin.

The engagement ends 912a, 922a engage with those tip ends of the shaft members 911, 921, which are disposed radially outwardly of the partition member 41, and the arm draw portions 912b, 922b are connected to the positive-electrode arm 913 and the negative-electrode arm 923.

According to the respective embodiments described above, the arm draw portions 912b, 922b are located radially outwardly from the positive-electrode body 912 and the negative-electrode body 922 with respect to the rotation axis direction of the commutator 60, and the torsion springs are wound outward from the inside. The arm draw portions 912b, 922b in the fifth embodiment are located radially inward, and the torsion springs are wound inward from the outside.

The arm draw portions 912b, 922b are located above the shaft members 911, 921. In addition, the shaft members 911, 921 include, on root portions thereof, inclination correcting portions 921a, which project radially in the shaft members 911, 921 to abut against the arm draw portions 912b, 922b on this side from the backside in FIG. 9.

FIGS. 10A and 10B show the inclination correcting portion 921a on a side of the negative-electrode spring 92. An alternate long and short dash line in FIGS. 10A and 10B indicates a center line of the spring 92. In addition, slant-hatched portion in the drawings indicate the inclination correcting portions 921a. In addition, since the inclination correcting portion on a side of the positive-electrode spring 91 is the same in structure as the inclination correcting portion 921a, an explanation therefore is omitted below.

As shown in FIGS. 10A and 10B, only a last turn of the negative-electrode body 922 located innermost, that is, only the arm draw portion 922b of the negative-electrode body 922 is located on the inclination correcting portion 921a.

In addition, according to the fifth embodiment, a positive-electrode guide wall 811a and a negative-electrode guide wall 821a, which construct the brush holders 811, 821, are defined in surfaces thereof, which are opposed to the positive-electrode body 912 and the negative-electrode body 922, with a positive-electrode groove 811b and a negative-electrode groove 821b, which axially extend. The positive-electrode arm 913 and the negative-electrode arm 923, respectively, are arranged in the positive-electrode groove 811b and the negative-electrode groove 821b. Therefore, the electrode arms 913, 923 can be made short as compared with those in the first to fourth embodiments.

Here, as shown in FIGS. 9 and 10A, the electrode arms 913, 923 include bent portions 913a, 923a and positions, in which the electrode arms 913, 923 bias the brushes 81, 82, and positions of the arm draw portions 912b, 922b get out of position relative to each other. In the present construction, reaction forces from the brushes 81, 82, which act on the electrode arms 913, 923, apply torsional moments on the electrode arms 913, 923 and torque acts on the electrode bodies 912, 922 about an axis L5, L6 in FIG. 9. Consequently, the electrode bodies 912, 922 are going to incline in directions, in which the arm draw portions 912b, 922b abut against the shaft members 911, 921. When the electrode bodies 912, 922 incline in this manner, directions (directions indicated by arrows P in FIG. 9), in which the electrode arms 913, 923 press down the brushes 81, 82, get out of directions, in which the brushes 81, 82 move. Thereby, the brushes 81, 82 cannot be biased perpendicularly against the commutator 60, and consequently, contact between the brushes 81, 82 and the commutator 60 becomes unstable.

In contrast, according to the fifth embodiment, the correcting portions 921a are defined in the shaft members 911, 921, so that it is possible to restrict the electrode bodies 912, 922 from inclining as described above. Therefore, it is possible to bias the brushes 81, 82 perpendicularly against the commutator 60, thereby enabling making contact between the brushes 81, 82 and the commutator 60 stable.

### Sixth Embodiment

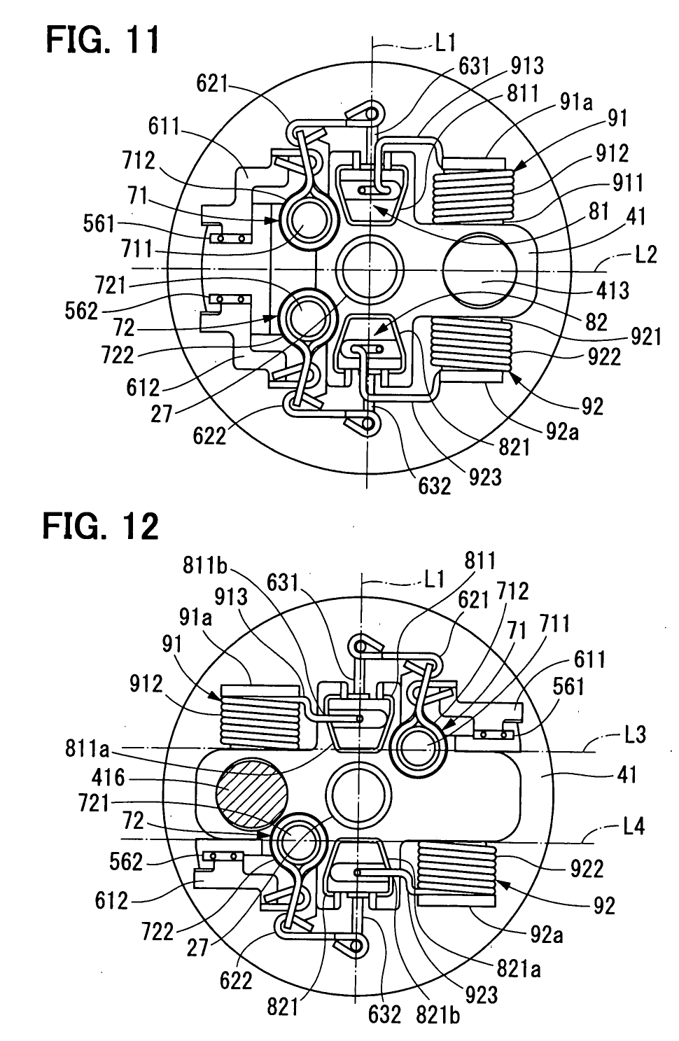

According to the sixth embodiment shown in FIG. 11, coming-off restricting members 91a, 92a are provided on tip ends of the shaft members 911, 921. The coming-off restricting members 91a, 92a make it hard to release engagement between the engagement ends 912a, 922a of the electrode bodies 912, 922 and the shaft members 911, 921, thereby enabling inhibiting the electrode bodies 912, 922 from coming off the shaft members 911, 921.

In addition, while according to the fifth embodiment, the arm draw portions 912b, 922b are located inwardly of the positive-electrode body 912 and the negative-electrode body 922 in the radial direction of the commutator 60, and the torsion springs are wound inward from the outside. The arm draw portions 912b, 922b according to the sixth embodiment are located radially outward and torsion springs are wound outward from the inside.

### Seventh Embodiment

According to the seventh embodiment shown in FIG. 12, the positive-electrode groove 811b and the negative-electrode groove 821b are defined in those surfaces of the guide walls 811a, 821a, which are opposed to the electrode body 912 and the electrode body 922. In addition, the arm draw portions 912b, 922b are located radially outward and torsion springs are wound outward from the inside. In addition, the positive-electrode spring 91 and a negative-electrode choke coil 72 are arranged in positions, which are symmetrical about an imaginary line L1 relative to positions of the positive-electrode spring 91 and the negative-electrode choke coil 72 in the first embodiment.

### Eighth Embodiment

According to the respective embodiments described above, fuel flowing from the fuel passage hole 413 into the brush accommodating passage 412 flows through the brush accommodating passage 412 into the fuel discharge portion 52 without being guided, and is discharged from the outlet 57. Therefore, fuel in the brush accommodating passage 412 is increased in pressure loss.

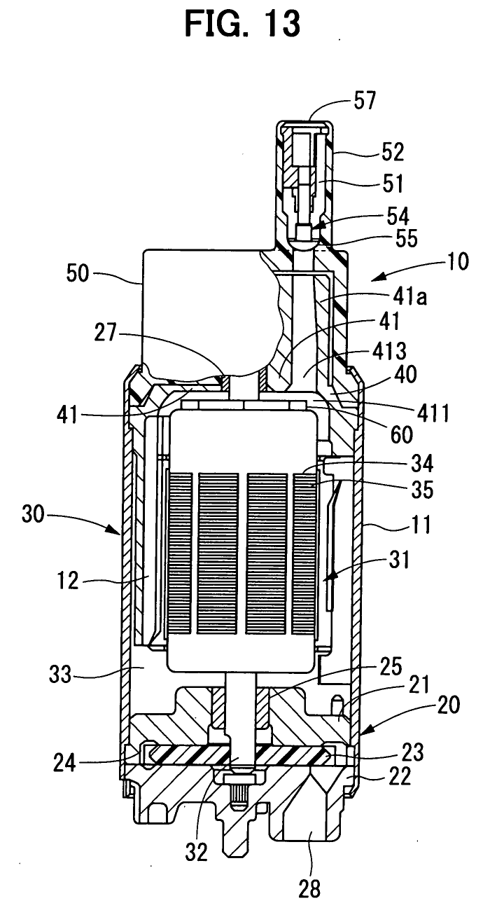

In contrast, according to the eighth embodiment shown in FIG. 13, the partition member 41 is provided with a piping member 41a, through which fuel is led to the fuel discharge portion 52 from the fuel passage hole 413. Therefore, pressure loss in fuel in the brush accommodating passage 412 can be reduced.

### Ninth Embodiment

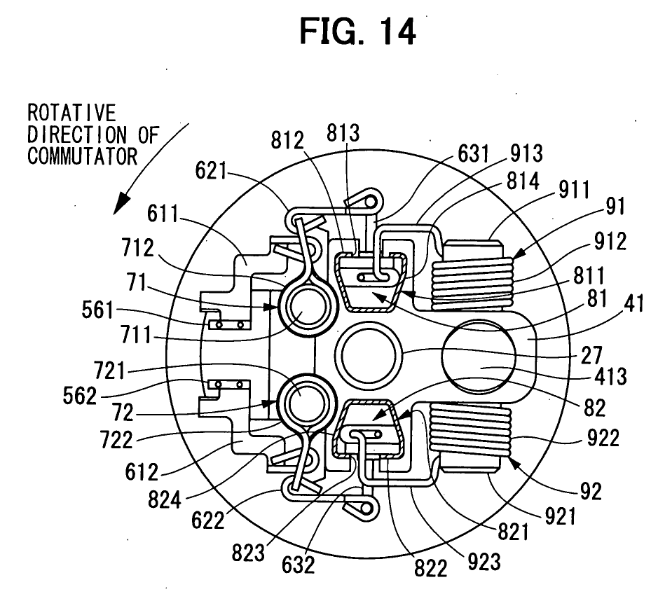

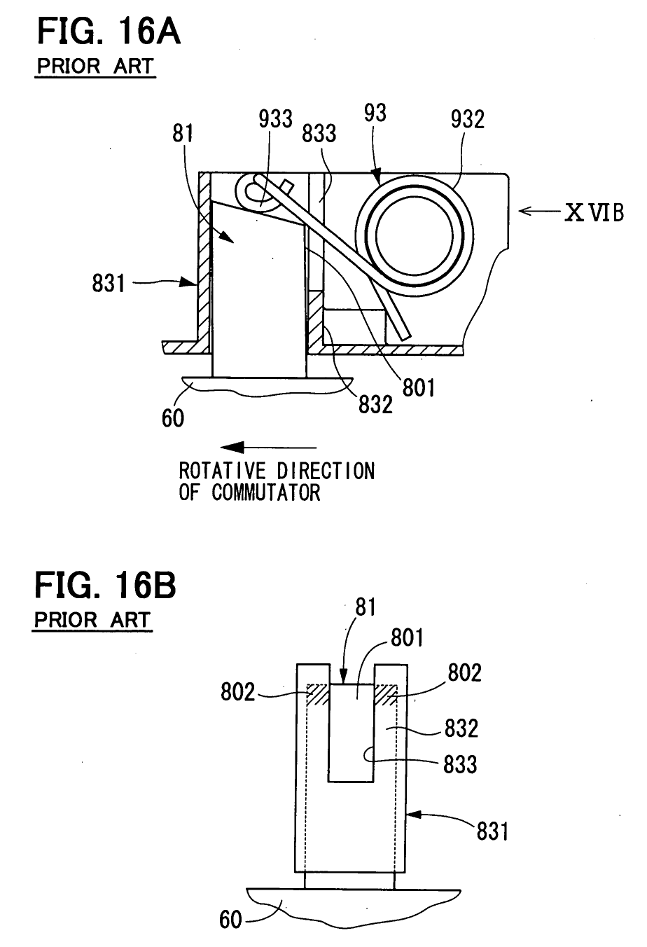

As shown in FIG. 14, both the brush holders 811, 821 are substantially trapezoidal when being viewed from the rotation axis. Wall portions 812, 822 located on the outer peripheral sides of the brush holders 811, 821 in the radial direction of the commutator 60 are respectively provided with a positive-electrode draw hole 813 and a negative-electrode draw hole 823. Similarly to the shape of the draw hole 833 shown in FIG. 16B, both the draw holes 813, 823 are groove-shaped with the wall portions 812, 822 notched axially downward from the upper ends thereof.

Hatched portions in FIG. 14 indicate upper end portions of the brush holders 811, 821 but do not indicate cross sections as hatched.

The positive-electrode arm 913 and the positive-electrode pigtail 631 are arranged in the positive-electrode draw hole 813. That is, the positive-electrode arm 913 and the positive-electrode pigtail 631 extend through the draw hole 813 radially outwardly of the fuel pump 10 from the interior of the positive-electrode holder 811.

The negative-electrode arm 923 and a negative-electrode pigtail 632 are arranged in the negative-electrode draw hole 823. That is, the negative-electrode arm 923 and the negative-electrode pigtail 632 extend through the draw hole 823 radially outwardly of the fuel pump 10 from the interior of the negative-electrode holder 821.

In addition, as shown in FIG. 4B, the electrode bodies 912, 922 of both the springs 91, 92, both the terminals 561, 562, both choke coils 71, 72, and both the brushes 81, 82 are arranged to overlap radially with respect to the rotation axis.

Both the springs 91, 92 are arranged on the opposite side of both the terminals 561, 562 and both the choke coils 71, 72 with respect to both the brushes 81, 82 when being viewed from the rotation axis of the commutator 60. Both the brushes 81, 82 are arranged to be symmetrical with respect to the rotation axis.

Here, those portions of the brush holders 811, 821, which are located on the opposite side to the forward side in the rotative direction of the commutator 60, are called wall portions 814, 824 (see FIG. 14). Those surfaces of upper portions of the brushes 81, 82, which are opposed to the wall portions 814, 824, are called wall portion opposed surfaces 801, 802. As shown in FIGS. 4B and 5, as the commutator 60 rotates, the brushes 81, 82 are applied with frictional force from the commutator 60 and the frictional force inclines the brushes 81, 82 in the holders 811, 821 (see FIG. 5), the wall portion opposed surfaces 801, 802 are biased against the wall portions 814, 824 (see FIG. 14).

In contrast, according to the present embodiment, the draw holes 813, 823 of the holders 811, 821, in which the electrode arms 913, 923 of the springs 91, 92 are arranged, are defined in the wall portions 812, 822 of the holders 811, 821, which are located on the outer peripheral sides in the radial direction of the commutator 60. Therefore, even when the brushes 81, 82 incline in the holders 811, 821 as the commutator 60 rotates, and the brushes 81, 82 are biased against the wall portions 814, 824, the draw holes 813, 823 are not located on the surface of the wall portions 814, 824. Accordingly, when the brushes 81, 82 are biased against the holders 811, 821, pressure receiving areas of the brushes 81, 82 for the holders 811, 821 are ensured to the maximum. Therefore, it is possible to decrease abrasive wear of the brushes 81, 82 by virtue of the brushes 81, 82 being biased against the holders 811, 821 as the commutator 60 rotates.

In addition, according to the present embodiment, the pigtails 631, 632 are arranged in the draw holes 813, 823. Therefore, the pigtails 631, 632 and the electrode arms 913, 923 use the draw holes 813, 823 in common. Thereby, as compared with the case where draw holes for pigtails are formed separately from the draw holes 813, 823, in which the electrode arms 913, 923 are arranged, the holders 811, 821 can be made simple in structure.

In addition, the draw holes 813, 823 are defined in the wall portions 812, 822 of the holders 811, 821, which are located on the outer peripheral sides in the radial direction of the commutator 60. Thereby, as compared with the case where draw holes are defined in the inner peripheral sides of the holders 811, 821, the distance between the positive-electrode pigtail 631 and the negative-electrode pigtail 632 can be increased. Accordingly, it is possible to decrease a fear that the positive-electrode pigtail 631 and the negative-electrode pigtail 632 make contact with each other to cause short-circuit.

### Tenth Embodiment

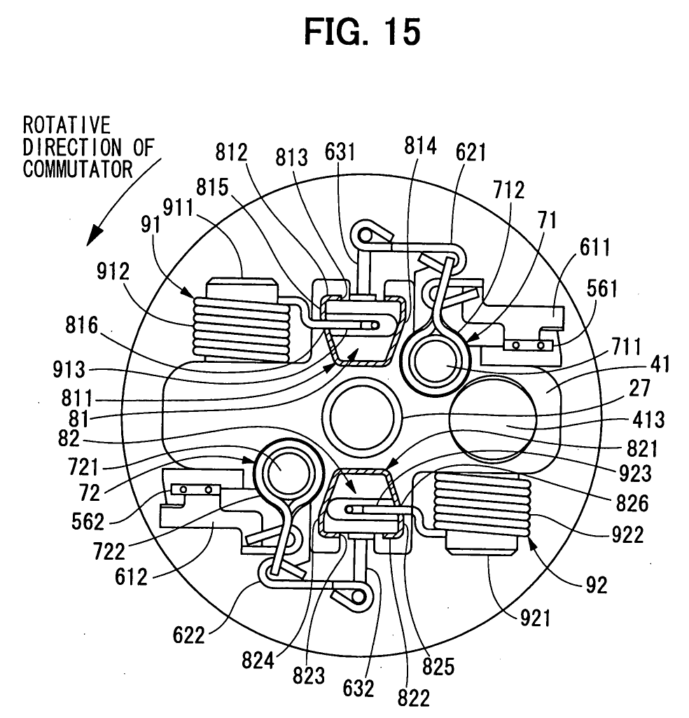

In the embodiment shown in FIG. 15, the draw holes 813, 823 for pigtails and draw holes 816, 826 for electrode arms are separately provided. Similarly to the ninth embodiment, the draw holes 813, 823 for pigtails are defined in the wall portions 812, 822 and groove-shaped with the wall portions 812, 822 notched axially downward from the upper ends thereof.

A positive-electrode draw hole 816 for the arm portion is defined in a wall portion 815 of the positive-electrode holder 811, which is located in the forward side in the rotative direction of the commutator 60. The negative-electrode draw hole 826 for the arm portion is defined in a wall portion 825 of a negative-electrode holder 821, which is located in the forward side in the rotative direction of the commutator 60. The draw holes 816, 826 for electrode arms are groove-shaped with the wall portions 815, 825 notched axially downward from the upper ends thereof.

In addition, according to the present embodiment, the positive-electrode spring 91 is arranged in a position opposed to the wall portion 815, on which the positive-electrode draw hole 816 for the arm portion is formed. In keeping with the arrangement, a positive-electrode choke coil 71 is arranged on the opposite side of the forward side in the rotative direction of the commutator 60 with respect to a positive-electrode brush 81.

According to the embodiment, the draw holes 816, 826 of the holders 811, 821, in which the electrode arms 913, 923 of the springs 91, 92 are arranged, are defined in the wall portions 815, 825 of the holders 811, 821, which are located on the forward side in the rotative direction of the commutator 60. Therefore, even when as the commutator 60 rotates, the brushes 81, 82 incline in the holders 811, 821 and the brushes 81, 82 are biased against the wall portions 814, 824, the draw holes 813, 823 are not located on the surfaces of the wall portions 814, 824. Accordingly, when the brushes 81, 82 are biased against the holders 811, 821, pressure receiving areas of the brushes 81, 82 for the holders 811, 821 are ensured to the maximum. Therefore, it is possible to decrease abrasive wear of the brushes 81, 82 by virtue of the brushes 81, 82 being biased against the holders 811, 821 as the commutator 60 rotates.

The draw holes 813, 816, 823, 826 are not limited to groove-shapes with the wall portions 812, 815, 822, 825 notched axially downward from the upper ends thereof but may be, for example, hole-shaped.

The draw holes 813, 823 may be defined in wall portions of the holders 811, 821, which are located on the inner peripheral sides in the radial direction, instead of being defined in the wall portions 812, 822, which are located on the outer peripheral sides in the radial direction of the commutator 60. Thereby, similarly to the ninth embodiment, when the brushes 81, 82 are biased against the holders 811, 821, pressure receiving areas of the brushes 81, 82 for the holders 811, 821 can be ensured to the maximum.

The brushes 81, 82 and the holders 811, 821 are not limited to substantially trapezoidal shapes when being viewed from the rotation axis but may be rectangular or circular in shape.

The pigtails 631, 632 are not limited to a structure, in which they extend radially outward from interiors of the holders 811, 821 in the rotation axis direction. The pigtails 631, 632 may be extended axially (vertical direction in FIG. 4B) and drawn outside from interiors of the holders 811, 821 instead of being arranged in the draw holes 813, 823.

### Eleventh Embodiment

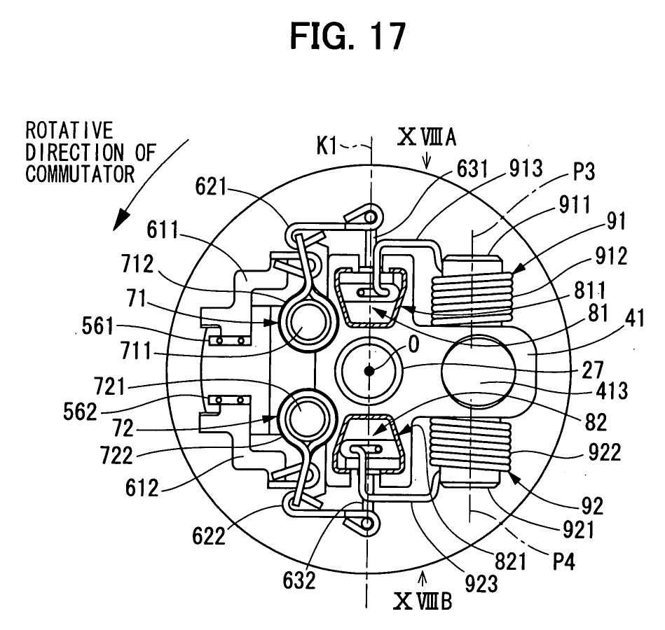

As shown in FIG. 17, both the terminals 561, 562 and both choke coils 71, 72 are arranged on the opposite side of an imaginary line K1 to both the electrode bodies 912, 922.

In addition, as shown in FIG. 4, the electrode bodies 912, 922 of both the springs 91, 92, both the terminals 561, 562, both the choke coils 71, 72, and both the brushes 81, 82 are arranged to overlap radially with respect to the rotation axis. Thereby, the fuel pump 10 can be downsized in the axial direction (vertical direction in FIG. 4).

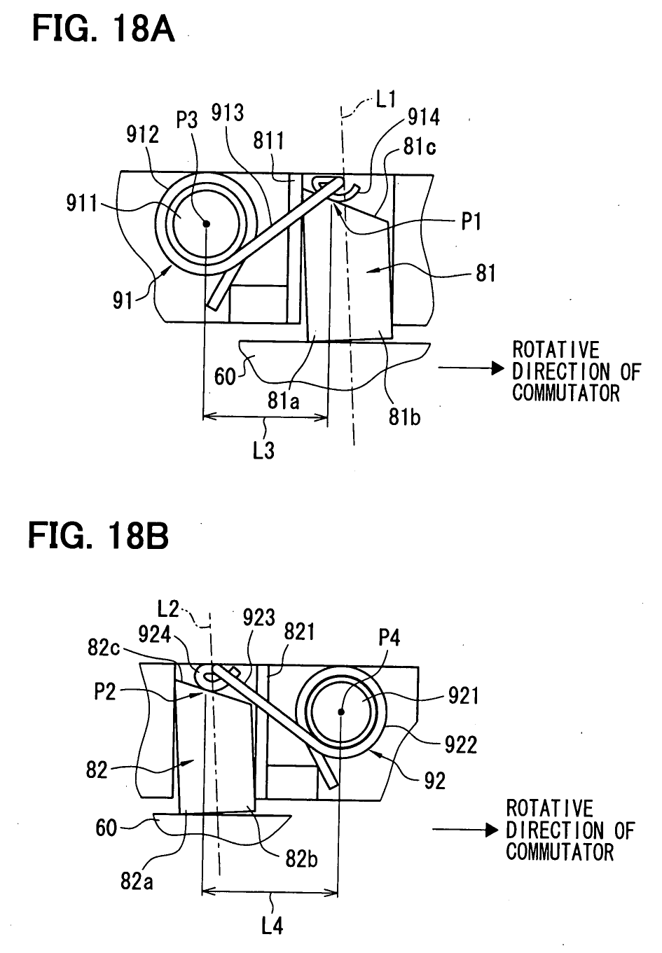

As shown in FIGS. 17, 18A, and 18B, the electrode arms 913, 923 are formed at tip ends thereof with abutments 914, 924, which are formed by bending a wire. More specifically, the abutments 914, 924 are curved to be convex on sides in contact with the brushes 81, 82. In addition, the abutments 914, 924 are curved so that bent ends of the abutments 914, 924 are directed toward the forward side in the rotative direction of the commutator 60. That is, as viewed along an arrow A in FIG. 17, a positive-electrode abutment 914 is curved counterclockwise and as viewed along an arrow B in FIG. 17, a negative-electrode abutment 924 is curved counterclockwise.

In addition, as shown in FIGS. 18A and 18B, inclined surfaces 81c, 82c are defined in upper end portions of the brushes 81, 82, that is, those portions, against which the abutments 914, 924 of the springs 91, 92 abut. Directions, in which the inclined surfaces 81c, 82c are inclined, are ones, in which total axial lengths shorten as they go on the forward side (on the right in FIGS. 18A and 18B) in the rotative direction of the commutator 60.

As shown in FIG. 18A, a force point position P1, in which the positive-electrode arm 913 is biased against the inclined surface 81c of the positive-electrode brush 81, is located on the opposite side of the forward side in the rotative direction of the commutator 60 with respect to a plane, which includes an axis L1 of the positive-electrode brush 81 and the rotation axis of the commutator 60. In addition, as shown in FIG. 18B, a force point position P2, in which the negative-electrode arm 923 is biased against the inclined surface 82c of the negative-electrode brush 82, is located on the opposite side of the forward side in the rotative direction of the commutator 60 with respect to an axis L2 of the negative-electrode brush 82.

In addition, force point positions P1, P2 in a state (state shown in FIGS. 18A and 18B), in which the brushes 81, 82 do not abrade, are located on the opposite side (upper side in FIGS. 18A and 18B) of the commutator 60 with respect to coil center points P3, P4.

As shown in FIG. 17, both the brushes 81, 82 are arranged to be symmetrical with respect to the rotation axis O when being viewed from the rotation axis of the commutator 60. Assuming that an imaginary line K1 passes the rotation axis O and the axes L1, L2 (see FIGS. 18A and 18B) of both the brushes 81, 82, the electrode bodies 912, 922 of both the springs 91, 92 are arranged on the same side with respect to the imaginary line K1.

As shown in FIG. 17, when being viewed from the rotation axis of the commutator 60, the electrode bodies 912, 922 are arranged so that the distance from the coil center point P3 of the positive-electrode body 912 to the imaginary line K1 and the distance from the coil center point P4 of the negative-electrode body 922 to the imaginary line K1 are made the same length. A length L3 (see FIG. 18A) of the positive-electrode arm 913 when being viewed from the rotation axis is set to be shorter than a length L4 (see FIG. 18B) of the negative-electrode arm 923. Thereby, both the force point positions P1, P2 are located on the opposite side to the forward side in the rotative direction as described above.

Here, those portions of surfaces of the brushes 81, 82 in contact with the commutator 60, which are located on the opposite side (on the left in FIGS. 18A and 18B) to the forward side in the rotative direction of the commutator 60 to begin making contact with the rotating commutator 60, are called entering side contact portions 81a, 82a. Those portions, which are located on the forward side (on the right in FIGS. 18A and 18B) in the rotative direction and of which contact with the rotating commutator 60 is released, are called release side contact portions 81b, 82b. An explanation will be given below to effects achieved by the embodiment.

When contact between the rotating commutator 60 and the brushes 81, 82 is released, electric discharge accompanying a residual current generates in some cases between the brushes 81, 82 and the commutator 60. Such electric discharge is decreased when forces, with which the entering side contact portions 81a, 82a of the brushes 81, 82 are biased against the commutator 60, are made greater than forces, with which the release side contact portions 81b, 82b are biased against the commutator 60. This is because an electric current flowing between the brushes 81, 82 and the commutator 60 passes much through regions, in which electric resistance becomes low, since the brushes 81, 82 are biased intensely against the commutator 60.

In view of this, according to the present embodiment, the force point positions P1, P2, at which the electrode arms 913, 923 are biased against the brushes 81, 82, are located on the opposite side of the forward side in the rotative direction of the commutator 60 with respect to the brushes 81, 82 with respect to the axes L1, L2.

Therefore, an extent, to which the brushes 81, 82 are biased against the commutator 60, is large on the entering side contact portions 81a, 82a as compared with the release side contact portions 81b, 82b. Consequently, a large amount of electric current flows through the entering side contact portions 81a, 82a as compared with the release side contact portions 81b, 82b. Thus, a residual current between the release side contact portions 81b, 82b and the commutator 60 decreases when the contact between the commutator 60 and the release side contact portions 81b, 82b is released. Accordingly, it is possible to suppress the electric discharge described above to extend the brushes 81, 82 and the commutator 60 in life.

Further, according to the present embodiment, the inclined surfaces 81c, 82c are defined in those portions of the brushes 81, 82, against which the abutments 914, 924 of the springs 91, 92 abut. Directions, in which the inclined surfaces 81c, 82c are inclined, are ones, in which total axial lengths shorten as they go on the forward side in the rotative direction of the commutator 60.

According to this, biasing forces acting at the force point positions P1, P2 act inclining through the inclined surfaces 81c, 82c on the opposite side of the forward side in the rotative direction with respect to the brushes 81, 82. Consequently, an extent, to which the brushes 81, 82 are biased against the commutator 60, is large on the entering side contact portions 81a, 82a as compared with the release side contact portions 81b, 82b. Accordingly, electric discharge between the brushes 81, 82 and the commutator 60 is further decreased, so that it is possible to further extend the brushes 81, 82 and the commutator 60 in life.

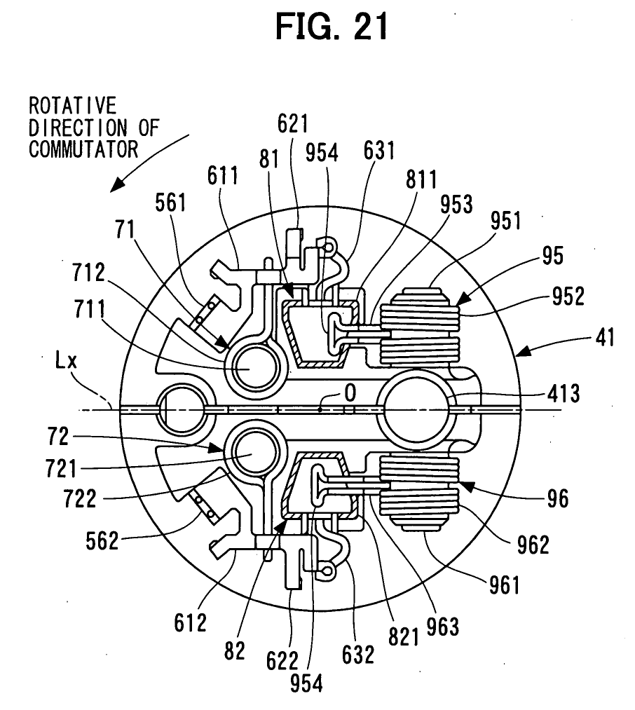

According to the present embodiment, the force point positions, at which the electrode arms are biased against the brushes, are located on the opposite side of the forward side in the rotative direction of the commutator with respect to the axes of the brushes. Therefore, even when the force point positions shift to the forward side in the rotative direction of the commutator as the brushes abrade, the force point positions are located on the opposite side to the forward side in the rotative direction as compared with the conventional construction shown in FIG. 21. Accordingly, it is possible to inhibit the brushes from being biased to the release side. Consequently, it is possible to decrease electric discharge between the brushes and the commutator, thereby enabling extending the brushes and the commutator in life.

### Twelfth Embodiment

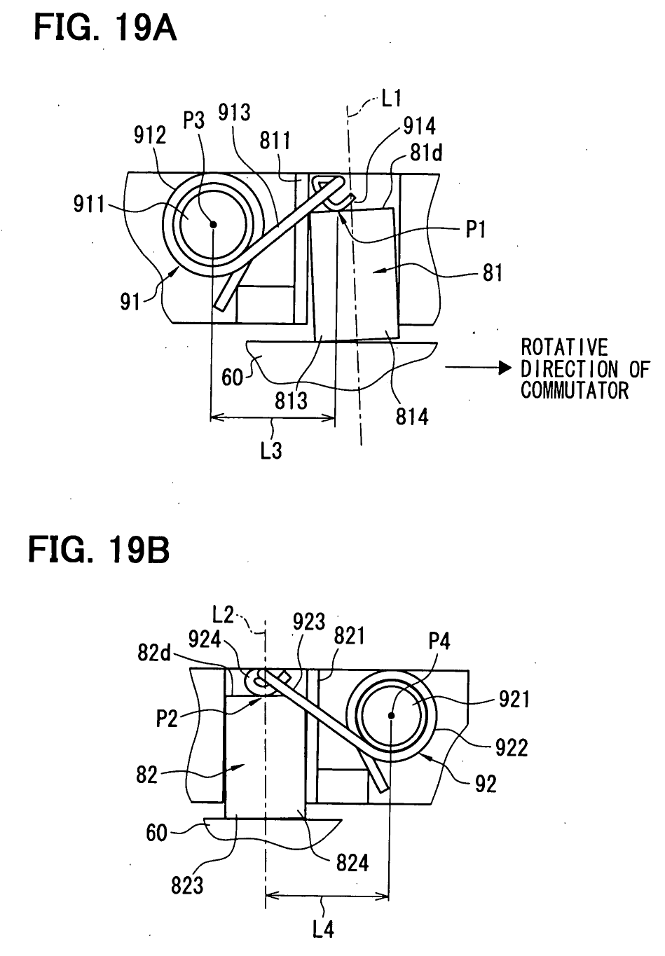

In the embodiment shown in FIGS. 19A and 19B, the inclined surfaces 81c, 82c are omitted. Those portions of the brushes 81, 82, against which the abutments 914, 924 abut, are defined by flat surfaces 81d, 82d, which extend substantially perpendicularly to axes L1, L2 of the brushes 81, 82.

Similarly to the eleventh embodiment, force point positions P1, P2, at which the electrode arms 913, 923 are biased against the brushes 81, 82, are located on the opposite side of the forward side in the rotative direction of the commutator 60 with respect to the axes L1, L2 of the brushes 81, 82. Therefore, similarly to the eleventh embodiment, it is possible to decrease a residual current between release side contact portions 81b, 82b and the commutator 60, thereby enabling extending the brushes 81, 82 and the commutator 60 in life.

### Thirteenth Embodiment

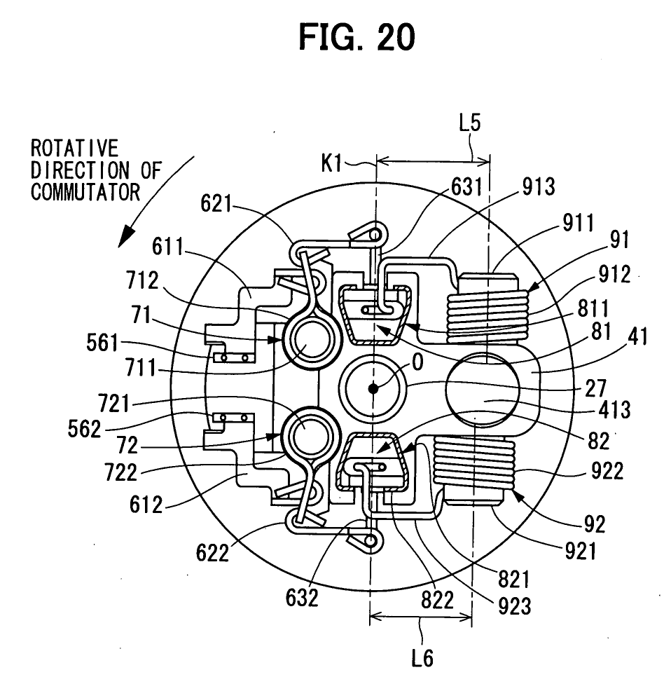

In the embodiment shown in FIG. 20, both the electrode arms 913, 923 are made the same in length. By arranging both the electrode bodies 912, 922 in a different manner from that in the eleventh embodiment, both force point positions P1, P2 are located on the opposite side to the forward side in the rotative direction.

When being viewed from the rotation axis of the commutator 60, both the brushes 81, 82 are arranged to be symmetrical with respect to the rotation axis O. Both the electrode bodies 912, 922 are arranged on the same side with respect to an imaginary line K1, and both the electrode arms 913, 923 are made the same in length. Both the electrode bodies 912, 922 are arranged so that the distance L5 from a coil center point P3 of the positive-electrode body 912 to the imaginary line K1 is made greater than the distance L6 from a coil center point P4 of the negative-electrode body 922 to the imaginary line K1. Thereby, as described above, both the force point positions P1, P2 are located on the opposite side to the forward side in the rotative direction.

### Fourteenth Embodiment

According to the fourteenth embodiment shown in FIG. 21, a positive-electrode spring 95 and a negative-electrode spring 96, which serve as biasing members, are different in shape from those in the eleventh embodiment. In addition, according to the fourteenth embodiment, components such as the conductive members 611, 621, pigtails 631, 632, and the like are different in shape from those in the eleventh embodiment but are substantially the same in function. According to the fourteenth embodiment, assuming that a straight line passing the rotation axis O is made an imaginary line Lx, the positive-electrode brush 81 and the negative-electrode brush 82 are arranged to be symmetrical with respect to the imaginary line Lx.

The positive-electrode spring 95 is wound around a shaft member 951. The positive-electrode spring 95 includes a positive-electrode body 952 wound around the shaft member 951. The positive-electrode spring 95 is wound from both axial ends of the shaft member 951 to an axial-central portion thereof, and a positive-electrode arm 953 projects from the central portion toward the positive-electrode brush 81. Likewise, the negative-electrode spring 96 is wound around a shaft member 961. The negative-electrode spring 96 includes a negative-electrode body 962 wound around the shaft member 961. The negative-electrode spring 96 is wound from both axial ends of the shaft member 961 to an axial-central portion thereof, and a negative-electrode arm 963 projects from the central portion toward the negative-electrode brush 82. In this manner, the positive-electrode body 952 of the positive-electrode spring 95 and the negative-electrode body 962 wound of the negative-electrode spring 96 are arranged perpendicularly to the imaginary line Lx.

The positive-electrode arm 953 of the positive-electrode spring 95 projects from the axial-central portion of the positive-electrode body 952 toward the positive-electrode brush 81. The opposite end of the positive-electrode arm 953 to the positive-electrode body 952 is in contact with the positive-electrode brush 81. A direction, in which the positive-electrode arm 953 project and extend from the axial-central portion of the positive-electrode body 952, and a contact point 954, at which the positive-electrode arm 953 and the positive-electrode brush 81 are in contact with each other, are arranged on substantially the same straight line.

The negative-electrode arm 963 of the negative-electrode spring 96 projects from the axial-central portion of the negative-electrode body 962 toward the negative-electrode brush 82. The opposite end of the negative-electrode arm 963 to the negative-electrode body 962 is in contact with the negative-electrode brush 82. A direction, in which the negative-electrode arm 963 project and extend from the axial-central portion of the negative-electrode body 962, and a contact point 964, at which the negative-electrode arm 963 and the negative-electrode brush 82 are in contact with each other, are arranged on substantially the same straight line.

According to the fourteenth embodiment, the positive-electrode holder 811 defines a groove, along which the positive-electrode arm 953 is movable in the rotation axis, on a wall portion opposed to the positive-electrode spring 95, in addition to a groove, along which the positive-electrode pigtail 631 is movable in the rotation axis. Likewise, the negative-electrode holder 821 defines a groove, along which the negative-electrode arm 963 is movable in the rotation axis, on a wall portion opposed to the negative-electrode spring 96, in addition to a groove, along which the negative-electrode pigtail 632 is movable in the rotation axis.

According to the fourteenth embodiment, the positive-electrode arm 953 projects from an axial-central portion of the positive-electrode spring 95, and the negative-electrode arm 963 projects from an axial-central portion of the negative-electrode spring 96. Therefore, a draw portion of the positive-electrode arm 953 of the positive-electrode spring 95, the positive-electrode arm 953, and the contact point 954 of the positive-electrode arm 953 with the positive-electrode brush 81 are arranged on substantially the same straight line. In addition, a draw portion of the negative-electrode arm 963 of the negative-electrode spring 96, the negative-electrode arm 963, and the contact point 964 of the negative-electrode arm 963 with the negative-electrode brush 82 are arranged on substantially the same straight line. Thereby, the positive-electrode spring 95 or the negative-electrode spring 96 is not formed midway thereof with any bent portion and surely is in contact with the positive-electrode brush 81 or the negative-electrode brush 82. Consequently, a biasing force of the positive-electrode spring 95 applies in a direction, in which the positive-electrode brush 81 is moved, that is, along the direction of the rotation axis, and a biasing force of the negative-electrode spring 96 applies in a direction, in which the negative-electrode brush 82 is moved. Thereby, inclinations of the positive-electrode brush 81 and the negative-electrode brush 82 to the rotation axis are decreased. Accordingly, it is possible to surely have the positive-electrode brush 81, the negative-electrode brush 82, and the commutator 60 sliding. Consequently, it is possible to reduce the positive-electrode brush 81 and the negative-electrode brush 82 in abrasion.

### Fifteenth Embodiment

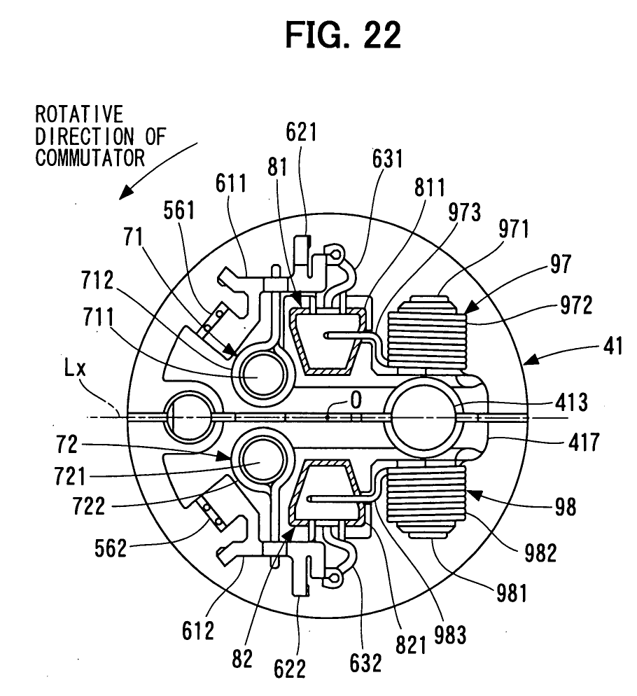

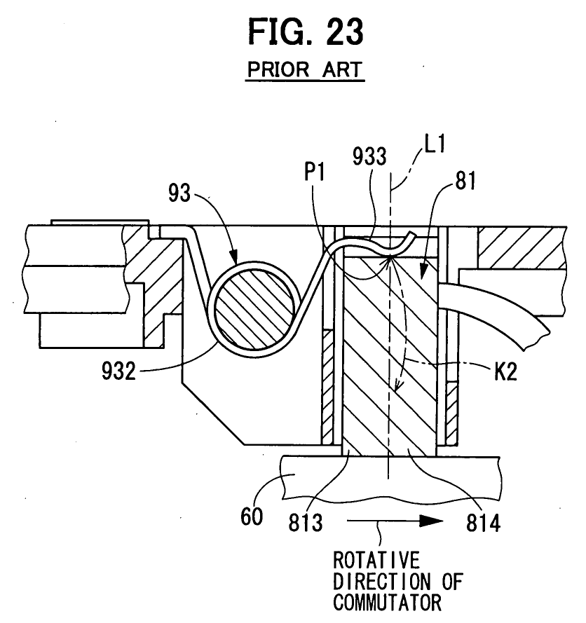

According to the fifteenth embodiment shown in FIG. 22, a positive-electrode spring 97 and a negative-electrode spring 98, which serve as biasing members, are different in shape from those in the eleventh embodiment. The remaining construction is substantially the same as that in the fourteenth embodiment. According to the fifteenth embodiment, assuming that a straight line passing the rotation axis O is made an imaginary line Lx, the positive-electrode brush 81 and a negative-electrode brush 82 are arranged to be symmetrical with respect to the imaginary line Lx.

In addition, according to the fifteenth embodiment, the partition member 41 of the motor casing 40 includes the fuel passage hole 413 in a position, which includes the imaginary line Lx. In addition, the partition member 41 includes a wall portion 417, which includes the fuel passage hole 413 inside and compartments between the positive-electrode brush 81 and the negative-electrode brush 82. The wall portion 417 includes the fuel passage hole 413 inside and projects on the opposite side to the commutator 60.

The positive-electrode spring 97 is wound around a shaft member 971. The positive-electrode spring 97 includes a positive-electrode body 972 wound around the shaft member 971. The positive-electrode spring 97 is wound around the wall portion 417 from an opposite side to the wall portion 417 in the axial direction of the shaft member 971 and a positive-electrode arm 973 is drawn from an end of the wall portion 417. The positive-electrode arm 973 is drawn from the positive-electrode body 972 toward the positive-electrode brush 81 and bent in the axial direction of the positive-electrode body 972. Further, the positive-electrode arm 973 is bent toward the positive-electrode brush 81 in the vicinity of an axial-central portion of the positive-electrode body 972 and has an end thereof in contact with the positive-electrode brush 81. That is, the positive-electrode arm 973 of the positive-electrode spring 97 is drawn from the positive-electrode body 972 and then projects from the axial-central portion of the positive-electrode body 972 toward the positive-electrode brush 81. An opposite end of the positive-electrode arm 973 to the positive-electrode body 972 is in contact with the positive-electrode brush 81.

The negative-electrode spring 98 is wound around a shaft member 981. The negative-electrode spring 98 includes a negative-electrode body 982 wound around the shaft member 981. The negative-electrode spring 98 is wound around the wall portion 417 from an opposite side to the wall portion 417 in the axial direction of the shaft member 981 and a negative-electrode arm 983 is drawn from an end thereof toward the wall portion 417. The negative-electrode arm 983 is drawn from the negative-electrode body 982 toward the negative-electrode brush 82 and bent in the axial direction of the negative-electrode body 982. Further, the negative-electrode arm 983 is bent toward the negative-electrode brush 82 in the vicinity of an axial-central portion of the negative-electrode body 982 and has an end thereof in contact with the negative-electrode brush 82. That is, the negative-electrode arm 983 of the negative-electrode spring 98 is drawn from the negative-electrode body 982 and then projects toward the negative-electrode brush 82 from the axial-central portion of the negative-electrode body 982. An opposite end of the negative-electrode arm 983 to the negative-electrode body 982 is in contact with the negative-electrode brush 82.

According to the fifteenth embodiment, the positive-electrode holder 811 defines a groove, along which the positive-electrode arm 973 is movable in the rotation axis, on a wall portion opposed to the positive-electrode spring 97, in addition to a groove, along which the positive-electrode pigtail 631 is movable in the rotation axis. Likewise, the negative-electrode holder 821 defines a groove, along which the negative-electrode arm 983 is movable in the rotation axis, on a wall portion opposed to the negative-electrode spring 98, in addition to a groove, along which the negative-electrode pigtail 632 is movable in the rotation axis.

According to the fifteenth embodiment, both the positive-electrode spring 97 and the negative-electrode spring 98 are constrained by having ends of the partition member 41 toward the wall portion 417 in contact with the wall portion 417. Therefore, even when the positive-electrode arm 973 and the negative-electrode arm 983 are bent midway thereof to be crooked, the positive-electrode body 972 and the negative-electrode body 982 are restricted in torsion by the wall portion 417. Consequently, a biasing force of the positive-electrode spring 97 applies in a direction, in which the positive-electrode brush 81 is moved, that is, in the rotation axis direction, through the positive-electrode arm 973, and a biasing force of the negative-electrode spring 98 applies in a direction, in which the negative-electrode brush 82 is moved, through the negative-electrode arm 983. Thereby, inclinations of the positive-electrode brush 81 and the negative-electrode brush 82 to the rotation axis are decreased. Accordingly, it is possible to surely have the positive-electrode brush 81, the negative-electrode brush 82, and the commutator 60 sliding, thereby enabling reducing the positive-electrode brush 81 and the negative-electrode brush 82 in abrasion.

According to the fifteenth embodiment, in order to provide the fuel passage hole 413, the wall portion 417 is formed to rise on the opposite side to the commutator 60 from the partition member 41. Therefore, by using the wall portion 417 beforehand provided on the partition member 41 to constrain torsion of the positive-electrode spring 97 and the negative-electrode spring 98, it is possible to stably ensure biasing forces of the positive-electrode brush 81 and the negative-electrode brush 82 without an increase in the number of parts.

The fourteenth embodiment has been described taking, as an example, that construction, in which the respective electrode arms 953, 963 are drawn from the axial-central portions of the respective springs 95, 96, and the fifteenth embodiment has been described taking, as an example, that construction, in which the respective electrode arms 973, 983 are drawn from ends of the respective springs 97, 98 toward the wall portion 417 and bent at central portions thereof. However, inclinations of the brushes due to torsion of the springs can be decreased by setting the springs in shape so that the draw portions of the electrode arms of the springs and the force point positions, at which the electrode arms and the brushes contact with each other, are located on substantially the same straight line. Accordingly, the springs and the electrode arms are not limited in shape to the examples in the fourteenth embodiment and the fifteenth embodiment but may be optionally set in shape.

### Other Embodiments

In the respective embodiments, the force point positions P1, P2 of the brushes 81, 82 are located on opposite sides (upper sides in FIGS. 18A and 18B) of the coil center points P3, P4 to the commutator 60. Alternatively, the force point positions P1, P2 may be located toward (lower sides in FIGS. 18A and 18B) the commutator 60 relative to the coil center points P3, P4.

The electric motor is applicable also to a single motor without the pump part 20.

In this manner, the invention is not limited to the respective embodiments described above, but applicable to various embodiments within a scope not departing from the gist of the invention. For example, featuring constructions of the respective embodiments described above, respectively, may be combined optionally.

What is claimed is:

1. A fuel pump comprising:
a case member having therein a fuel passage, an inlet of fuel, and an outlet of fuel;
a pump part provided in the fuel passage to draw fuel from the inlet to pressure feed the fuel to the outlet;
an armature provided to a motor accommodating passage downstream of the pump part in the fuel passage for rotating to drive the pump part;
a commutator provided to the motor accommodating passage to rectify an electric current fed to the armature;
a positive-electrode brush and a negative-electrode brush, which are provided to a brush accommodating passage downstream of the motor accommodating passage in the fuel passage, and are in contact with the commutator to conduct electricity;
a positive-electrode biasing member and a negative-electrode biasing member provided to the brush accommodating passage respectively to bias the positive-electrode brush against the commutator and the negative-electrode brush against the commutator; and
a partition member partitioning the fuel passage into the motor accommodating passage and the brush accommodating passage, and defining a fuel passage hole through which fuel passes from the motor accommodating passage to the brush accommodating passage,
wherein the positive-electrode biasing member includes a positive-electrode body, which is resiliently deformable and arranged offset from the positive-electrode brush when being viewed from a rotation axis of the commutator, and a positive-electrode arm for transmitting biasing force from the positive-electrode body to the positive-electrode brush,
the negative-electrode biasing member includes a negative-electrode body, which is resiliently deformable and arranged offset from the negative-electrode brush when being viewed from the rotation axis of the commutator, and a negative-electrode arm for transmitting biasing force from the negative-electrode body to the negative-electrode brush, and
the fuel passage hole is located between the positive-electrode body and the negative-electrode body when being viewed from the rotation axis of the commutator.

2. The fuel pump according to claim 1, wherein the outlet of the case member is arranged offset from the rotation axis when being viewed from the rotation axis of the commutator.

3. The fuel pump according to claim 2, wherein the fuel passage hole of the partition member overlaps the outlet when being viewed from the rotation axis of the commutator.

4. The fuel pump according to claim 1, further comprising:
a positive-electrode terminal conducting electric power to the positive-electrode brush; and
a negative-electrode terminal conducting electric power to the negative-electrode brush,
wherein the positive-electrode terminal and the negative-electrode terminal are arranged on an opposite side of the fuel passage hole with respect to an imaginary line, which connects the positive-electrode brush with the negative-electrode brush, when being viewed from the rotation axis of the commutator.

5. The fuel pump according to claim 1, further comprising:
a positive-electrode choke coil electrically connected to the positive-electrode brush to decrease electric noise; and
a negative-electrode choke coil electrically connected to the negative-electrode brush to decrease electric noise,
wherein the positive-electrode choke coil and the negative-electrode choke coil are arranged on an opposite side of the fuel passage hole with respect to an imaginary line, which connects the positive-electrode brush with the negative-electrode brush, when being viewed from the rotation axis of the commutator.

6. The fuel pump according to claim 5, further comprising:
a positive-electrode terminal conducting electric power to the positive-electrode brush; and
a negative-electrode terminal conducting electric power to the negative-electrode brush; and
wherein the positive-electrode terminal is arranged on an opposite side of the fuel passage hole with respect to the positive-electrode choke coil, when being viewed from the rotation axis of the commutator, and
the negative-electrode terminal is arranged on an opposite side of the fuel passage hole with respect to the negative-electrode choke coil, when being viewed from the rotation axis of the commutator.

7. A fuel pump comprising:
a case member having therein a fuel passage, an inlet of fuel, and an outlet of fuel;
a pump part provided in the fuel passage to draw fuel from the inlet to pressure feed the fuel to the outlet;
an armature provided to a motor accommodating passage downstream of the pump part in the fuel passage for rotating to drive the pump part;
a commutator provided to the motor accommodating passage to rectify an electric current fed to the armature;
a positive-electrode brush and a negative-electrode brush, which are provided to a brush accommodating passage downstream of the motor accommodating passage in the fuel passage, and are in contact with the commutator to conduct electricity;
a positive-electrode biasing member and a negative-electrode biasing member provided to the brush accommodating passage respectively to bias the positive-electrode brush against the commutator and the negative-electrode brush against the commutator;
a partition member partitioning the fuel passage into the motor accommodating passage and the brush accommodating passage, and defining a fuel passage hole through which fuel passes from the motor accommodating passage to the brush accommodating passage;
a positive-electrode terminal and a negative-electrode terminal conducting electric power;
a positive-electrode choke coil electrically connecting the positive-electrode terminal with the positive-electrode brush to decrease electric noise; and
a negative-electrode choke coil electrically connecting the negative-electrode terminal with the negative-electrode brush to decrease electric noise,
wherein the positive-electrode biasing member includes a positive-electrode body, which is resiliently deformable and arranged offset from the positive-electrode brush when being viewed from a rotation axis of the commutator, and a positive-electrode arm for transmitting biasing force from the positive-electrode body to the positive-electrode brush,
the negative-electrode biasing member includes a negative-electrode body, which is resiliently deformable and arranged offset from the negative-electrode brush when being viewed from the rotation axis of the commutator, and a negative-electrode arm for transmitting biasing force from the negative-electrode body to the negative-electrode brush,
the positive-electrode choke coil is arranged on an opposite side of the positive-electrode biasing member with respect to the positive-electrode brush when being viewed from the rotation axis of the commutator,
the negative-electrode choke coil is arranged on an opposite side of the negative-electrode biasing member with respect to the negative-electrode brush when being viewed from the rotation axis of the commutator,
the positive-electrode terminal is arranged on an opposite side of the positive-electrode brush with respect to the positive-electrode choke coil when being viewed from the rotation axis of the commutator, and
the negative-electrode terminal is arranged on an opposite side of the negative-electrode brush with respect to the negative-electrode choke coil when being viewed from the rotation axis of the commutator.

8. The fuel pump according to claim 1, further comprising:
a positive-electrode pillar extending perpendicularly to the rotation axis; and
a negative-electrode pillar extending perpendicularly to the rotation axis,
wherein the positive-electrode body and the negative-electrode body are torsion springs respectively wound around the positive-electrode pillar and the negative-electrode pillar,
the positive-electrode body and the negative-electrode body have one ends, which are located outward in a radial direction of the commutator, and are respectively engaged with the positive-electrode pillar and the negative-electrode pillar, and
the positive-electrode body and the negative-electrode body have other ends, which are located toward a center in the radial direction of the commutator, and are respectively connected to the positive-electrode arm and the negative-electrode arm.

9. The fuel pump according to claim 8, wherein the positive-electrode pillar and the negative-electrode pillar are provided on the partition member.

10. The fuel pump according to claim 8, further comprising:
a positive-electrode guide wall, which guides the positive-electrode brush along the rotation axis, and has a positive-electrode groove extending along the rotation axis; and
a negative-electrode guide wall, which guides the negative-electrode brush along the rotation axis, and has a negative-electrode groove extending along the rotation axis,
wherein the positive-electrode arm and the negative-electrode arm are respectively located in the positive-electrode groove and the negative-electrode groove.

11. The fuel pump according to claim 10,
wherein the positive-electrode guide wall has a surface, which is opposed to the positive-electrode body, and defining the positive-electrode groove, and
the negative-electrode guide wall has a surface, which is opposed to the negative-electrode body, and defining the negative-electrode groove.

12. The fuel pump according to claim 8,
wherein the positive-electrode pillar has a tip end provided with a coming-off restricting member for latching the one end of the positive-electrode body, and
the negative-electrode pillar has a tip end provided with a coming-off restricting member for latching the one end of the negative-electrode body.

13. The fuel pump according to claim 1, further comprising:
a positive-electrode pillar extending perpendicularly to the rotation axis; and
a negative-electrode pillar extending perpendicularly to the rotation axis,
wherein the positive-electrode body and the negative-electrode body are torsion springs respectively wound around the positive-electrode pillar and the negative-electrode pillar,
the positive-electrode body and the negative-electrode body have one ends respectively engaged with the positive-electrode pillar and the negative-electrode pillar,
the positive-electrode body and the negative-electrode body have other ends respectively connected with the positive-electrode arm and the negative-electrode arm, and
the positive-electrode pillar and the negative-electrode pillar have tip ends provided with coming-off restricting members for respectively latching the one ends of the positive-electrode body and the negative-electrode body.

14. The fuel pump according to claim 1, further comprising:
a positive-electrode pillar extending perpendicularly to the rotation axis; and
a negative-electrode pillar extending perpendicularly to the rotation axis,
wherein the positive-electrode body and the negative-electrode body are torsion springs respectively wound around the positive-electrode pillar and the negative-electrode pillar,
the positive-electrode body and the negative-electrode body have one ends, which are respectively engaged with the positive-electrode pillar and the negative-electrode pillar, and other ends, which are respectively connected to the positive-electrode arm and the negative-electrode arm, and
the positive-electrode pillar and the negative-electrode pillar include inclination correcting portions, which radially project from radially inward thereof to respectively abut against the other ends of the positive-electrode body and the negative-electrode body.

15. The fuel pump according to claim 1, wherein the partition member includes a piping member through which fuel is led from the fuel passage hole to the outlet.

16. An electric motor comprising:
an armature;
a commutator for rectifying an electric current supplied to the armature;
a brush being in contact with the commutator relative to a direction of a rotation axis of the commutator;
a holder being in a cylindrical-shape extending along the rotation axis for supporting the brush therein movably along the rotation axis; and
a biasing member for biasing the brush against the commutator,
wherein the biasing member includes a body portion, which is resiliently deformable and arranged outside the holder when being viewed from the rotation axis,
the biasing member includes an arm portion located in a draw hole defined in the holder to extend from the body portion into the holder, and
the holder has a wall portion defining the draw hole in an outer periphery or an inner periphery thereof with respect to a radial direction of the commutator.

17. The electric motor according to claim 16, further comprising:
a pigtail connected to the brush to conduct electricity,
wherein the pigtail is located in the draw hole.

18. The electric motor according to claim 17,
wherein the brush and the holder are arranged in plural in a rotative direction of the commutator, and
the wall portion of the holder has the outer periphery with respect to the radial direction of the commutator, the outer periphery defining the draw hole.

19. A fuel pump comprising:
an electric motor according to claim 16; and
a pump part driven by rotation of the armature to pressurize fuel as drawn,
wherein the electric motor and the pump part are integrally connected.

20. An electric motor comprising:
an armature;
a commutator for rectifying an electric current supplied to the armature;
a positive-electrode brush and a negative-electrode brush being in contact with the commutator with respect to a direction of a rotation axis of the commutator;
a positive-electrode holder being in a cylindrical-shape extending along the rotation axis for supporting the positive-electrode brush therein movably along the rotation axis;
a negative-electrode holder being in a cylindrical-shape extending along the rotation axis for supporting the negative-electrode brush therein movably along the rotation axis;
a positive-electrode biasing member for biasing the positive-electrode brush against the commutator; and
a negative-electrode biasing member for biasing the negative-electrode brush against the commutator,
wherein the positive-electrode biasing member includes a positive-electrode body, which is resiliently deformable and arranged outside the positive-electrode holder when being viewed from the rotation axis,
the positive-electrode biasing member includes a positive-electrode arm arranged in a positive-electrode draw hole defined in the positive-electrode holder to extend from the positive-electrode body into the positive-electrode holder,
the negative-electrode biasing member includes a negative-electrode body, which is resiliently deformable and arranged outside the negative-electrode holder when being viewed from the rotation axis,
the negative-electrode biasing member includes a negative-electrode arm arranged in a negative-electrode draw hole defined in the negative-electrode holder to extend from the negative-electrode body into the negative-electrode holder,
the positive-electrode holder has a wall portion, which is located on a forward rotation side of the positive-electrode holder in a rotative direction of the commutator, and defining the positive-electrode draw hole, and
the negative-electrode holder has a wall portion, which is located on a forward rotation side of the negative-electrode holder in the rotative direction of the commutator, and defining the negative-electrode draw hole.

21. The electric motor according to claim 20, further comprising:
a positive-electrode pigtail connected to the positive-electrode brush to conduct electricity; and
a negative-electrode pigtail connected to the negative-electrode brush to conduct electricity,
wherein the positive-electrode pigtail is in the positive-electrode draw hole, and
the negative-electrode pigtail is in the negative-electrode draw hole.

22. A fuel pump comprising:
an electric motor according to claim 20; and
a pump part driven by rotation of the armature to pressurize fuel as drawn,
wherein the electric motor and the pump part are integrally connected.

23. An electric motor comprising:
an armature;
a commutator for rectifying an electric current supplied to the armature;
a brush being in contact with the commutator; and
a biasing member for biasing the brush toward the commutator,
wherein the biasing member includes a body portion, which is resiliently deformable and arranged offset from the brush when being viewed from a rotation axis of the commutator,
the biasing member includes an arm portion, which abuts against the brush to transmit biasing force of the body portion to the brush, and
the arm portion is biased against the brush at a force point position, which is located on an opposite side of a forward side of the commutator 60 in a rotative direction, with respect to an axis of the brush.

24. The electric motor according to claim 23,
wherein the brush includes an inclined surface on an opposite end to the commutator,
the brush has a total axial length decreasing on the inclined surface toward the forward side in the rotative direction, and
the force point position is located on the inclined surface.

25. The electric motor according to claim 23,
wherein the brushes are arranged in plural to be symmetrical with respect to the rotation axis when being viewed from the rotation axis,
the biasing member is provided to each of the brushes, and
the arm portion has a length from the body portion to the force point position, the length being different for each of the biasing members.

26. The electric motor according to claim 23,
wherein the brushes are arranged in plural to be symmetrical with respect to the rotation axis when being viewed from the rotation axis,
the biasing member is provided to each of the brushes, and
the body portion is arranged so that a distance from an axis of the body portion to an axis of the brush is different for each of the biasing members.

27. The electric motor according to claim 23,
wherein the brushes are arranged in plural to be symmetrical with respect to an axis of symmetry, which is an imaginary straight line passing through the rotation axis when being viewed from the rotation axis,
the biasing member is provided to each of the brushes, the biasing member having a central portion relative to an axial direction thereof, the axial direction being perpendicular to the imaginary straight line, and
the arm portion projects from the central portion of the biasing member toward the brush.

28. The electric motor according to claim 23, wherein the biasing member has a central portion relative to an axial direction thereof, the central portion, a center of the arm portion, and a center of the brush being located on substantially the same straight line.

29. The electric motor according to claim 23, further comprising:
a motor casing provided on a side of the commutator of the armature to rotatably support the brush, and being at a predetermined distance from the commutator,
wherein the brushes are arranged in plural on the motor casing to be symmetrical interposing therebetween a wall portion, which includes, as an axis of symmetry, an imaginary straight line passing through the rotation axis when being viewed from the rotation axis,
the biasing member is provided for each of the brushes to interpose therebetween the wall portion, and
the arm portion extends from an end in the vicinity of the wall portion toward an axial-central portion of the biasing member, and is bent, and projects from the axial-central portion of the biasing member toward the brushes.

30. The electric motor according to claim 29, wherein the biasing member has an end in the vicinity of the wall portion, the end being in contact with the wall portion.

31. A fuel pump comprising:
an electric motor according to claim 23; and
a pump part driven by rotation of the armature to pressurize fuel as drawn,
wherein the electric motor and the pump part are integrally connected.
